(19) United States
(12) Patent Application Publication
(10) Pub. No.: US 2026/0290191 A1
(43) Pub. Date: Sep. 24, 2026

(54) SYSTEM

(71) Applicant: SoftBank Group Corp., Tokyo (JP)

(72) Inventor: Tao JIANG, Tokyo (JP)

(73) Assignee: SoftBank Group Corp., Tokyo (JP)

(21) Appl. No.: 19/564,248

(22) Filed: Mar. 12, 2026

(30) Foreign Application Priority Data
Mar. 19, 2025 (JP) 2025-045064

(51) Int. Cl. G09B 7/04; G06Q 50/20; G09B 7/12

(52) U.S. Cl. CPC G09B 7/04; G06Q 50/205; G09B 7/12

(57) ABSTRACT

A system includes a processor configured to: retrieve related questions from a database based on user-selected learning information and select questions of varying difficulty; receive user answers, evaluate them against an evaluation criterion, and quantify the user's degree of understanding; generate a prompt sentence based on the quantified understanding and input it into a generative AI model to propose a learning plan; monitor learning progress and generate notifications to provide support or request instructor intervention when necessary; retrieve questions related to the selected learning information, apply a filtering algorithm, and select questions appropriate for the user's learning level; and generate a prompt sentence for producing new questions and input it into the generative AI model.

### CROSS-REFERENCE TO RELATED APPLICATION

This application is based on and claims priority under 35 USC 119 from Japanese Patent Application No. 2025-045064 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional e-learning and computer-aided instruction systems typically select questions and learning materials based on static rule sets or coarse-grained difficulty categorizations, and are therefore limited in their ability to adapt to individual learner differences in real time. In particular, such systems often fail to (i) accurately quantify a learner's understanding level from question responses, (ii) translate that quantified understanding into a fine-tuned learning plan, (iii) dynamically adjust learning content and methods as the learner's progress changes, and (iv) integrate generative AI in a controlled and context-aware manner for generating new questions and adaptive learning resources. As a result, learners may receive questions that are too easy or too difficult, learning plans that are not well aligned with their current state, and support or instructor intervention that is delayed or not triggered at all. Furthermore, existing systems frequently lack an integrated mechanism for visualizing learning levels and progress in a form that is easily understood by both learners and instructors, thereby making it difficult to perform timely interventions and individualized guidance.

### SUMMARY

To solve the above problems, the present invention provides a system comprising a processor, wherein the processor is configured to perform a series of interrelated operations that tightly couple learner assessment, adaptive planning, generative AI utilization, and progress visualization. Specifically, the processor is configured to, based on learning information selected by a user, retrieve related questions from a database and select questions having different difficulty levels, to receive answers from the user, evaluate the answers according to an evaluation criterion, and quantify a degree of understanding of the user, and to generate, based on the quantified degree of understanding, prompt sentences for proposing learning plans to a generative AI model and input the prompt sentences into the generative AI model. In addition, the processor is configured to monitor learning progress and generate notifications for providing support or requesting intervention by an instructor when necessary, to again retrieve questions related to the selected learning information and apply a filtering algorithm so as to select questions suitable for a current learning level of the user, and to generate prompt sentences for generating new questions by using the generative AI model and input the prompt sentences into the generative AI model. Furthermore, the processor is configured to generate prompt sentences for dynamically changing proposals of learning plans, learning materials, and learning methods according to the degree of understanding and learning progress of the user, to input the prompt sentences into the generative AI model, and to provide an interactive dashboard having a data updating function so as to visualize a learning level and allow both the learner and the instructor to confirm learning progress in real time. In this manner, the system realizes highly adaptive and individualized learning support that continuously refines questions, content, and support actions on the basis of up-to-date learner data.

The term “learning information” refers to information representing a subject, topic, chapter, unit, or other pedagogical content area that is selected by a user as a target for study or assessment.

The term “question” refers to an assessment item stored in a database, including at least a problem statement and one or more expected answers or correct solutions, and optionally associated metadata such as difficulty level, subject, and topic.

The term “difficulty level” refers to a classification of a question or learning material indicating its relative complexity or required prior knowledge, such as beginner, intermediate, or advanced, which is used to match content to a user's learning level.

The term “database” refers to any structured data storage system, including relational databases, NoSQL databases, or comparable repositories, that stores questions, user data, learning materials, and associated metadata in a form retrievable by the processor.

The term “evaluation criterion” refers to one or more rules, thresholds, rubrics, or algorithms used by the processor to determine correctness of answers and to calculate scores, performance indicators, or other measures of a user's response quality.

The term “degree of understanding” refers to a quantitative or quasi-quantitative measure, such as a numerical score, percentage, or level classification, that represents the extent to which a user is assessed to have mastered particular learning information based on evaluation of question responses.

The term “learning plan” refers to a structured set of recommended learning actions, sequences, or goals, including, for example, suggested topics, exercises, resources, and time allocations, tailored to the user's degree of understanding and learning progress.

The term “learning material” refers to content provided to support learning, including but not limited to textbooks, articles, web pages, problem sets, videos, interactive exercises, and other digital or non-digital educational resources.

The term “learning method” refers to a recommended mode or strategy of learning, such as visual learning, text-based learning, practice-focused learning, or mixed approaches, which defines how learning materials are to be presented or used by the user.

The term “learning progress” refers to temporal changes in a user's learning status, including accumulation of test results, changes in degree of understanding, completion of learning materials, and transitions between difficulty or learning levels over time.

The term “learning level” refers to a representation of a user's overall capability or proficiency for specific learning information, which is used to determine suitable difficulty levels of questions and materials and may change as the user's understanding evolves.

The term “prompt sentence” refers to text or other machine-readable input generated by the processor and provided to a generative AI model, the content of which instructs the generative AI model to output a learning plan, new questions, explanations, or other educational content.

The term “generative AI model” refers to a machine learning model, such as a large language model or comparable generative system, that is capable of generating text, questions, explanations, or other content in response to input prompt sentences.

The term “notification” refers to data generated by the processor to inform a user, instructor, or external system of a condition related to learning progress, such as the need for support, recommended intervention, or completion of a learning milestone.

The term “instructor” refers to a human teacher, tutor, coach, or other person responsible for providing guidance, feedback, or intervention in the learning process, who may be notified by the system based on the user's learning progress.

The term “filtering algorithm” refers to a computational procedure executed by the processor to select or rank questions or materials from a larger set according to predefined criteria, such as relevance to selected learning information and suitability for the user's learning level.

The term “interactive dashboard” refers to a graphical user interface that presents learning-related information and metrics, and that allows real-time or near real-time updating and user interaction, such as selecting views, filtering data, or accessing detailed progress information.

The term “data updating function” refers to the capability of the system to refresh, modify, or newly incorporate learning status data into the interactive dashboard in response to new test results, user activities, or time-based events.

The term “visualize a learning level” refers to presenting information about a user's learning level or understanding in a perceptible form, such as charts, graphs, indicators, or color codes, enabling users and instructors to readily recognize the user's current status and trends.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

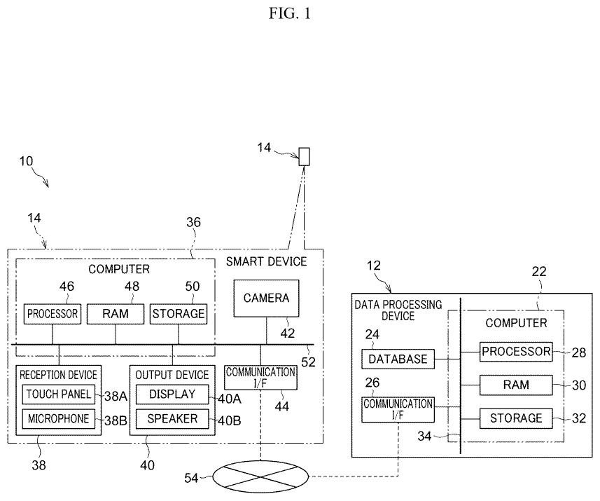

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

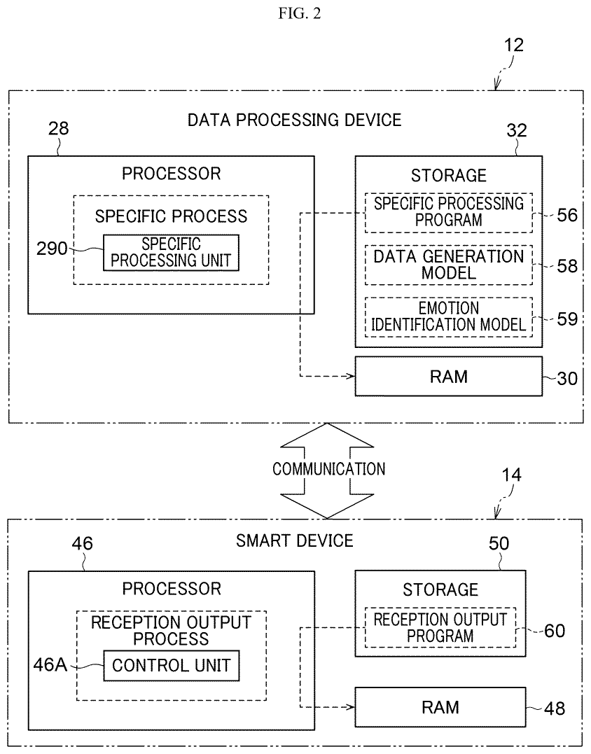

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented learning management systems generally rely on static rule sets or simple scoring logic to select problems and generate learning plans. Such systems typically retrieve problems from a database using fixed filters, calculate a score per session, and present predetermined learning materials based on coarse difficulty levels. As a result, these systems suffer from several technical limitations in terms of information processing and system control.

First, conventional systems do not tightly integrate historical answer logs, fine-grained comprehension indices, and topic-wise proficiency estimates into a unified learner state representation that can drive subsequent data processing. Processing of answer data is often limited to simple aggregation, and does not provide a dynamically updated learner model that is directly usable as machine-readable input for further automated computation. This limits the system's ability to automatically adapt database queries, filtering operations, and content generation processes at runtime.

Second, conventional systems do not use a structured prompt-generation pipeline that converts internal state information (such as learning level, progress degree, and topic-specific weaknesses) into machine-readable natural language instructions for a generative AI model. Existing approaches may invoke a generative model with manually crafted or coarse prompts, but they do not systematically encode database-derived learner state information, problem selection conditions, output format constraints, and difficulty conditions into prompt sentences. This leads to unstable quality of generated content, inconsistent difficulty control, and inefficient use of computational resources.

Third, conventional systems do not provide a coordinated mechanism that merges database-based problem selection and generative problem creation under a single control flow. Static systems either rely solely on pre-authored problems or use generative models in isolation, without executing a unified filtering algorithm that considers both re-searched problem information and newly generated problem information, in light of updated learner state information and progress metrics. This fragmentation prevents the system from maintaining consistent coverage and difficulty across sessions and across different content sources. Fourth, conventional systems lack an integrated feedback loop in which machine learning algorithms continuously update learner state information and learning progress degrees, and in which these updated values drive subsequent search, filtering, prompt generation, and visualization processes. As a result, the underlying computer processes do not form a closed-loop control system that can automatically optimize the flow of data retrieval, problem selection, generative content creation, and visualization based on real-time learner performance.

Fifth, conventional systems often provide dashboards that are updated only at coarse intervals and are not directly bound to underlying recalculation of learner state and comprehension indices. There is no systematic coupling between event-driven or periodic recomputation of learner metrics and the generation of visualization data for interactive dashboards. This results in stale or lagging visual representations of learning levels, which reduce the effectiveness of instructor intervention and hinder timely adjustments to learning plans. Accordingly, there is a need for an improved computer-implemented system and server architecture that (i) computes detailed learner state information from answer logs using machine learning algorithms, (ii) translates such internal states into structured prompt sentences for a generative AI model, (iii) integrates database-based problem selection with AI-based problem generation under a unified filtering and merging process, and (iv) continuously recomputes and visualizes learner state and progress in near real time. Such a system should improve how the computer selects, generates, and manages educational content by enhancing the way data is processed, combined, and used to control further computation within the system.

The specific processing by the specific processing unit 290 of the data processing device 12 in Example 1 is realized by the following means.

The present invention provides a server comprising a processor and a memory storing instructions, wherein the processor is configured to receive learning target information selected by a user terminal, generate learning request information including identification information associated with the learning target information, perform a search process on a set of problem information stored in a storage device based on the learning request information, and select problem information having a plurality of difficulty levels in accordance with a learner level estimated from past usage history information and evaluation result information; to receive answer information from the user terminal, perform correctness determination and partial-match determination of the answer information in accordance with predefined evaluation criterion information, and calculate a numerical comprehension index for a learner; to input the comprehension index and the usage history information as feature data into a machine learning algorithm, and calculate learner state information indicating at least a learning level and topic-wise proficiency of the learner; to generate, based on the learner state information and the learning target information, a prompt sentence in a natural language specifying at least one of learning plan information, learning material information, and learning method information as learning proposal content, and transmit the prompt sentence as input data to a generative AI model; to receive response information from the generative AI model, structure the learning proposal content of the response information into structured data, store the structured data in association with the comprehension index and the learner state information in the storage device, and transmit the structured data as output data to the user terminal; to calculate a learning progress degree based on at least the learner state information, the usage history information, and the answer information, and, when the learning progress degree satisfies a predetermined condition, generate notification information including support request information or instructor intervention request information, and transmit the notification information to at least one of the user terminal and an instructor terminal; to execute a filtering algorithm that performs a re-search process and a filtering process on the set of problem information based on at least the learner state information and the learning progress degree, and select problem information suitable for a current learning level of the learner and a weak area of the learner; to generate, based on at least the learner state information, the learning target information, and condition information including a desired problem format, a prompt sentence that explicitly specifies an output format and a difficulty condition, input the prompt sentence to the generative AI model to cause the generative AI model to generate new problem information, and integrate the new problem information with the problem information selected by the re-search process and the filtering process; and to generate visualization data indicating a learning situation on a time axis and on a topic basis based on at least the comprehension index, the learner state information, and the learning progress degree, and transmit the visualization data to the user terminal so that an interactive display screen having a data update function is provided to allow a user and an instructor to confirm a learning level and learning progress of the learner in substantially real time. This enables the computer system to implement an integrated, closed-loop control flow in which machine-calculated learner state information and progress metrics drive database querying, filtering, structured prompt generation for a generative AI model, merging of database and AI-generated problems, and real-time visualization, thereby improving how the computer processes educational data, generates content, and manages adaptive learning operations.

The term “learning target information” refers to information indicating at least one subject, topic, or concept that a learner intends to study and that is selected by a user via a user interface of a user terminal.

The term “learning request information” refers to data generated by the server based on learning target information, the data including identification information or parameters used to search for problem information or learning content in a storage device.

The term “problem information” refers to data representing at least one practice item, exercise, or question, and optionally including associated answer information, difficulty information, topic information, and explanation information.

The term “storage device” refers to at least one computer-readable medium, such as a database system or file storage system, configured to store problem information, learner-related information, and model-related information.

The term “user terminal” refers to any information processing apparatus used by a learner, including at least one processor, memory, display, and input interface, and configured to communicate with the server over a communication network.

The term “instructor terminal” refers to any information processing apparatus used by an instructor or supervisor, including at least one processor, memory, display, and input interface, and configured to receive learner-related information and notifications from the server.

The term “usage history information” refers to data indicating past interactions of a learner with the system, including at least past problem presentations, answer submissions, timestamps, and performance records.

The term “evaluation result information” refers to data representing results of evaluating a learner's answers, including at least correctness information, partial correctness information, and scores.

The term “answer information” refers to data indicating responses submitted by a learner to problem information, including selected options, free-text answers, and associated metadata.

The term “evaluation criterion information” refers to data defining rules, thresholds, or patterns used by the server to determine correctness, partial correctness, or other evaluation outcomes for answer information.

The term “comprehension index” refers to a numerical indicator calculated by the server that represents a degree of understanding of a learner with respect to at least one topic, problem set, or time period.

The term “feature data” refers to numerical or categorical values derived from usage history information, evaluation result information, or comprehension indices, and used as input to a machine learning algorithm.

The term “machine learning algorithm” refers to a computational procedure implemented in software that processes feature data using a trained model to produce at least one prediction or classification, such as a learner level or topic-wise proficiency.

The term “learner state information” refers to data computed by the server using a machine learning algorithm or other computation, the data indicating at least a current learning level, topic-wise proficiency, and other state variables associated with a learner.

The term “learning level” refers to a classification or numerical value indicating a general level of difficulty or proficiency of a learner, such as beginner, intermediate, or advanced.

The term “topic-wise proficiency” refers to information indicating degrees of understanding of a learner with respect to individual topics or subtopics.

The term “learning plan information” refers to data describing at least a schedule, sequence, or set of recommended learning activities, problem sets, or review sessions for a learner.

The term “learning material information” refers to data specifying at least one learning resource, such as text content, documents, or media content, that is recommended to a learner.

The term “learning method information” refers to data indicating at least one learning strategy or approach, such as practice style, review method, or study pattern, recommended to a learner.

The term “learning proposal content” refers to a set of one or more of learning plan information, learning material information, and learning method information that is generated or refined by the server and/or a generative AI model.

The term “prompt sentence” refers to a text sequence in a natural language that encodes instructions, constraints, or conditions and is transmitted from the server to a generative AI model as input for generating output data.

The term “generative AI model” refers to a machine-learned model configured to generate text or other content in response to input data, such as a prompt sentence, by using stored model parameters.

The term “response information” refers to data output from a generative AI model in response to a prompt sentence, including generated problems, explanations, or learning proposal content.

The term “structured data” refers to data organized according to a predefined schema or format, such as a set of fields in a record, that can be programmatically processed by the server.

The term “learning progress degree” refers to a numerical or categorical indicator computed by the server that represents a degree of progression of a learner over time, including improvement or regression in performance.

The term “support request information” refers to data indicating that a learner requests assistance, guidance, or clarification from the system or an instructor.

The term “instructor intervention request information” refers to data indicating that the system recommends or triggers an intervention by an instructor based on learner state information or learning progress degree.

The term “notification information” refers to data transmitted from the server to a user terminal or an instructor terminal to indicate at least one of a support request, an intervention request, a status update, or an alert.

The term “filtering algorithm” refers to a computational procedure that selects, ranks, or excludes problem information from a larger set based on at least learner state information, learning progress degree, difficulty information, or topic information.

The term “condition information” refers to data specifying constraints or requirements for content generation or problem selection, including at least desired problem format, difficulty condition, and output format.

The term “new problem information” refers to problem information generated by a generative AI model in response to a prompt sentence and not previously stored as part of the static problem information set.

The term “visualization data” refers to data formatted for rendering graphical or tabular representations of learner-related metrics, including at least comprehension indices, learner state information, and learning progress degrees.

The term “interactive display screen” refers to a user interface screen presented on a user terminal or instructor terminal that displays visualization data and allows user interaction such as selection, filtering, or request submission.

The term “data update function” refers to functionality of the server and user interface that updates visualization data and displayed metrics in response to recalculated learner state information, comprehension indices, or answer information, on a periodic or event-driven basis.

The term “time axis” refers to a representation of chronological progression used in visualization data to display changes in learner-related metrics over time.

The term “topic basis” refers to a representation in which learner-related metrics are organized or displayed according to topics or subtopics rather than solely by time or session.

In one embodiment, a server cooperates with one or more terminals operated by users and instructors to implement the claimed system. The server includes at least one processor, a main memory, a nonvolatile storage device, and a network interface. The processor of the server executes program modules stored in the memory to perform the functions described below. The terminal includes at least one processor, a memory, a display device, an input device such as a touchscreen, and a communication interface. The terminal executes a browser or a native application to provide a graphical user interface and to communicate with the server over a communication network.

The server stores, in the storage device, a problem data store, a learner data store, a model data store, and a log data store. The problem data store includes problem records, each record including at least a problem identifier, problem text, topic identifier, subject identifier, difficulty value, correct answer data, and optional explanation data. The learner data store includes learner records, each record including a learner identifier, usage history information, comprehension indices, learner state information, and learning plan information. The log data store includes prompt sentences transmitted to a generative AI model, response information received from the generative AI model, and system operation logs.

The server executes a web application module or an application programming interface module that exchanges data with the terminal using a structured data format. The server exposes endpoints through the network interface so that the terminal can transmit learning target information, answer information, and support requests, and receive problem information, structured learning proposal content, and visualization data.

The terminal displays a user interface that includes selection elements such as dropdown lists, checkboxes, and buttons. The terminal allows the user to select learning target information, including at least a subject and a topic, and optionally a preferred difficulty level or a type of problem format. The terminal generates a request message that includes the selected learning target information and identification information for the user, and the terminal transmits the request message to the server via the communication interface.

The server receives the request message and generates learning request information. The server accesses the problem data store using a database management module that executes structured queries. The server uses the learning target information to search the problem data store for problem information that matches the subject and topic indicated by the learning target information. The server retrieves a set of candidate problem records, each including a difficulty value and topic identifier.

The server accesses the learner data store to obtain usage history information and evaluation result information associated with the learner identifier contained in the request. The server constructs feature data from the usage history information and the evaluation result information. In one embodiment, the server constructs a feature vector including at least values representing total number of answered problems, recent accuracy by topic, average time per problem, distribution of difficulties of previously solved problems, and counts of incorrect answers by topic.

The server inputs the feature vector into a machine learning algorithm to compute learner state information. In one embodiment, the server uses a neural network model of a feedforward architecture. The server stores in the model data store a model that includes multiple fully connected layers, each layer comprising a weight matrix and a bias vector, and nonlinear activation functions. The server computes an output vector from the neural network, where one output component represents a continuous learning level score and additional components represent topic-wise proficiency scores. The server maps the continuous learning level score to discrete difficulty bands, and the server uses the topic-wise proficiency scores to identify weak topic areas. The server thereby generates learner state information that includes a learning level classification, a set of topic-wise proficiency indicators, and a confidence score.

The server filters the candidate problem records according to the learner state information. The server applies a filtering algorithm that selects problems whose difficulty values lie within a range determined by the learning level classification. The server further applies topic-based filters to ensure that a proportion of selected problems targets topics classified as weak areas. The server may apply randomization within these constraints to avoid repeated presentation of the same sequence of problems. The server then prepares a subset of problem information suitable for the current learner state.

The server receives answer information from the terminal when the user provides responses to presented problems. The server compares each answer with the stored correct answer data in the problem data store. For multiple-choice problems, the server performs a direct comparison between a submitted choice identifier and a stored correct choice identifier. For free-text problems, the server performs string normalization and may compute similarity scores using vectorized representations of text, and the server applies thresholds defined in evaluation criterion information to determine correctness or partial correctness. The server updates evaluation result information and calculates a comprehension index for the learner based on the evaluation result information and problem metadata such as difficulty values. The comprehension index can be a normalized score representing the learner's overall understanding in the relevant topic and time window.

The server updates the learner data store with the new comprehension index and with updated usage history information including timestamps, problem identifiers, and evaluation outcomes. The server repeats the feature construction and machine learning algorithm execution using the updated records, thereby generating refreshed learner state information. Because the server feeds freshly computed feature vectors into the neural network and updates mappings from outputs to difficulty bands and topic priorities, the server maintains a dynamic learner model that changes in response to actual performance data.

The server generates a prompt sentence in a natural language to request content from a generative AI model. The server constructs the prompt sentence using a prompt generation module that assembles template segments and inserts learner state information, learning target information, and condition information including desired problem format, output format, and difficulty conditions. The server may generate a prompt sentence for problem generation as follows:

“Generate 5 intermediate-level multiple-choice questions about the major events and consequences of World War II.

Output each question with four answer options and indicate which option is correct.

Use language that is appropriate for a high school student.”

The server may generate a prompt sentence for learning plan generation as follows:

“Based on the following learner profile, generate a concise study plan to improve understanding of World War II.

The learner is at an intermediate level and shows low proficiency in the causes and long-term consequences of the war.

Propose specific learning activities, recommended reading materials, and practice methods suitable for daily 30-minute sessions over one week.”

The server transmits the prompt sentence, together with control parameters such as maximum output length and generation temperature, to the generative AI model. In one embodiment, the serv-er accesses a generative AI model implementing a transformer architecture, which includes an embedding layer, multiple self-attention layers, feedforward layers, and normalization layers. The server sends the prompt sentence as a token sequence. The generative AI model computes attention weights for each token pair, propagates intermediate representations through the layers, and produces output tokens that form response information.

The server receives the response information, which may include generated problem texts, answer options, explanations, learning plan descriptions, and learning method suggestions. The server performs syntax checks and structure extraction on the response information. The server may use simple parsing rules or a secondary classifier to segment the generated text into structured data elements corresponding to question text, answer options, correct answer labels, explanation sections, schedule entries, and recommended resources. The server stores this structured data in the learner data store and the problem data store, marking newly created entries as generated content.

The server integrates generated problem information with problem information retrieved from the problem data store by applying additional selection and ordering rules. The server may ensure that generated problems fill gaps in topic coverage or difficulty coverage that are not adequately represented in the preexisting problem set. By combining database problems and generated problems under explicit difficulty and topic constraints derived from learner state information, the server improves both coverage and personalization while controlling computational effort and data volume.

The server generates learning plan information, learning material information, and learning method information by combining the structured data from the generative AI model with locally stored templates and resource metadata. The server may map recommended activities to specific problem identifiers and resource identifiers in the storage device, and the server may arrange these activities on a time axis according to a schedule. The server stores the resulting learning plan information as a structured record that associates the learner identifier, target topics, and time slots with specific problems and materials.

The server calculates a learning progress degree using a progression model that considers changes in comprehension indices and learner state information over time. The server may compute a slope of accuracy over a defined window, a trend in difficulty levels successfully solved, and reductions in error rates for previously weak topics. The server uses the learning progress degree to determine whether the learner is stagnating, improving, or regressing.

When the learning progress degree satisfies certain conditions, such as persistent low performance or abrupt drops in accuracy, the server generates notification information that includes support request information or instructor intervention request information. The server transmits this notification information to the user terminal and/or the instructor terminal, which then displays alerts or recommended actions.

The server generates visualization data for presentation on the terminal. The server uses the learner state information, comprehension indices, and learning progress degree to populate data structures representing graphs, such as time series curves for accuracy and difficulty, bar charts of topic proficiency, and progress indicators for learning plan completion. The server encodes these data structures in a format readable by a visualization component on the terminal. The terminal receives the visualization data and renders interactive charts and dashboards that allow the user and the instructor to explore the learner's performance and learning trajectory. The terminal may allow the user to select different time ranges or topics and to trigger updates. When the user interacts with the dashboard, the terminal transmits interaction events to the server, which logs these events and may update the visualization data based on newly recalculated learner state information.

The server thereby implements a closed-loop control of educational data processing. Because the server continuously updates feature data, recomputes learner state information using a neural network model, regenerates prompt sentences containing explicit constraints, and integrates database-derived and generated content under a unified filtering and merging logic, the server improves computational efficiency and precision of problem selection and content generation. Conventional systems that rely on static rules require manual tuning or repeated human intervention to adjust difficulty and topical coverage; in contrast, the described system programmatically adapts to learner behavior by exploiting structured internal state representations.

The use of a generative AI model is not limited to replacing human content creation. The server incorporates the generative AI model as a controlled component within a broader computational pipeline. The server constrains the generative AI model by embedding difficulty values, topic identifiers, and output format requirements in the prompt sentences, and by applying post-processing filters to the response information. The server also logs prompt sentences and responses, and the server may retrain the machine learning algorithm or adjust parameters of the prompt generation module based on empirical performance measures stored in the log data store. This design reduces variability in generated content, improves consistency of difficulty control, and lowers the need for repeated human review, thereby improving technical performance in terms of throughput and response latency.

In one variation, the server uses a different machine learning algorithm such as a gradient-boosted decision tree model rather than a neural network. The server still constructs feature vectors, but the internal structure of the model changes. The server retrieves model parameters such as tree structures and split thresholds from the model data store and applies them to compute learner state information. In another variation, the server uses a recurrent neural network or a temporal transformer that explicitly handles sequences of learner interactions and learns temporal patterns in performance.

In another embodiment, the server executes communication optimization by grouping multiple prompt sentences into a single request to the generative AI model, or by caching prior responses and reusing them for learners with similar learner state information. The server thereby reduces communication overhead and latency when interacting with the generative AI model. The server may also compress visualization data before transmitting it to the terminal, which reduces network bandwidth usage without significantly degrading quality of the displayed dashboards.

The terminal may be implemented as a smartphone, a tablet computer, a laptop computer, or a desktop computer. The terminal executes a browser or application that performs local validation of user input and local rendering of visualization data. The terminal reduces load on the server by executing client-side operations such as chart rendering and state management, while the server concentrates on heavy computations such as learner state estimation, problem selection, and generative AI interaction.

The user interacts with the terminal to select learning targets, answer problems, review explanations, and request support. The user does not need to manage internal states or manually adjust difficulty levels, because the system automatically adapts content based on measured performance data. The instructor interacts with the instructor terminal to review dashboards, respond to intervention requests, and optionally override or refine learning plans. The server exposes configuration options that allow an instructor to adjust thresholds for notifications and to prioritize certain topics or skills.

By combining these structural components and computational procedures, the system improves computer technology beyond simple automation of human tasks. The server implements specific data structures for learner state information and feature vectors, uses trained machine learning models and neural network architectures to transform raw answer data into actionable internal states, generates carefully constructed prompt sentences to control a generative AI model, and merges generated content with database content using nontrivial filters and rules. This combination yields technical effects including improved accuracy of difficulty matching, decreased latency in content selection, reduced manual configuration of learning plans, and more efficient use of network and computation resources.

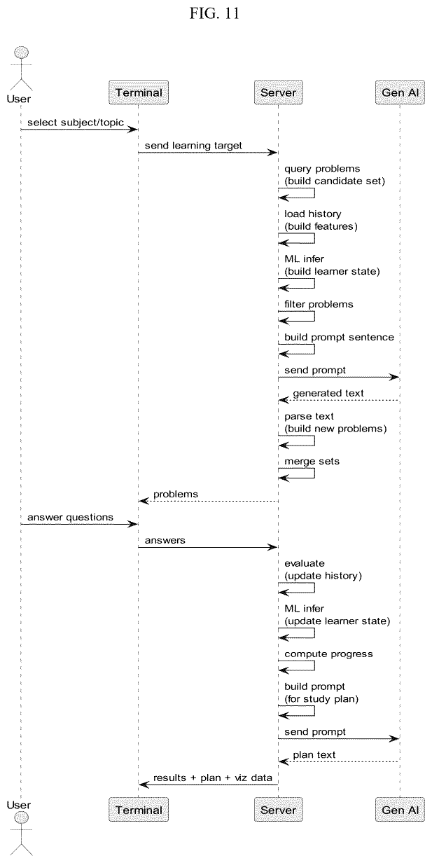

The following describes the processing flow using FIG. 11.

### Step 1:

The terminal displays a selection screen and receives learning target information from the user.

The user operates the terminal to select at least a subject and a topic via dropdown lists, checkboxes, and buttons.

The terminal converts the selected values into learning target information including a user identifier, a subject identifier, and a topic identifier.

The terminal sets the learning target information as input, serializes it into a request message, and transmits the request message to the server over a network.

The output of Step 1 is the request message containing learning target information sent to the server.

### Step 2:

The server receives the request message and generates learning request information.

The server parses the message, extracts the user identifier, subject identifier, and topic identifier, and stores them in an internal data structure.

The server combines these elements with additional parameters such as a current timestamp and a session identifier to form learning request information.

The input of Step 2 is the request message from the terminal, and the output of Step 2 is the learning request information stored in the server memory.

### Step 3:

The server retrieves candidate problem information from a storage device based on the learning request information.

The server uses the subject identifier and topic identifier to construct a query to the problem data store.

The server executes the query, which filters problem records by subject and topic, and obtains a set of candidate problem records including problem text, difficulty values, and correct answers.

The input of Step 3 is the learning request information, and the output of Step 3 is a candidate problem set held in the server memory.

### Step 4:

The server retrieves usage history information and evaluation result information for the user and constructs feature data.

The server accesses the learner data store using the user identifier to fetch past answers, timestamps, correctness flags, difficulty values of solved problems, and topic identifiers.

The server aggregates these values to compute numerical features such as recent accuracy by topic, average solution time, number of attempts per difficulty, and error counts per topic.

The server concatenates these numerical features into a feature vector.

The input of Step 4 is the user identifier included in the learning request information and historical records from the learner data store, and the output of Step 4 is a feature vector representing the current learner status.

### Step 5:

The server computes learner state information by executing a machine learning algorithm on the feature vector.

The server loads model parameters of a trained model, such as weight matrices and bias vectors of a neural network, from the model data store.

The server multiplies the feature vector by the first weight matrix, adds the corresponding bias vector, and applies an activation function to generate an intermediate layer output; the server repeats these operations across successive layers to compute a final output vector.

The server interprets elements of the output vector as a learning level score and topic-wise proficiency scores, and maps the learning level score to discrete difficulty bands.

The input of Step 5 is the feature vector, and the output of Step 5 is learner state information including the learning level classification and topic-wise proficiency indicators.

### Step 6:

The server filters the candidate problem set based on the learner state information.

The server applies a filtering algorithm that selects problems whose difficulty values fall within a difficulty band corresponding to the learning level classification and whose topics either match the learning target topic or are identified as weak topics.

The server may apply a random shuffle to the filtered list and limit the number of problems to a preset maximum.

The input of Step 6 is the candidate problem set and the learner state information, and the output of Step 6 is a filtered problem set suitable for the current learner.

### Step 7:

The server generates a prompt sentence for a generative AI model to create additional problem information.

The server uses the learning target information, the learner state information, and constraints such as desired problem format and number of problems to fill in a template in natural language.

The server, for example, generates a prompt sentence such as:

“Generate 5 intermediate-level multiple-choice questions about the major events and consequences of World War II.

Output each question with four answer options and indicate which option is correct.

Use language that is appropriate for a high school student.”

The server stores this prompt sentence in the log data store for traceability.

The input of Step 7 is the learning target information, the learner state information, and condition information, and the output of Step 7 is a constructed prompt sentence stored in memory and logs.

### Step 8:

The server calls the generative AI model with the prompt sentence and receives response information.

The server transmits the prompt sentence, together with control parameters such as maximum token count and temperature, to the generative AI model through an API.

The generative AI model processes the prompt sentence and generates text representing problems, answer options, and correct answers.

The server receives the generated text in a response payload and verifies that the response is complete.

The input of Step 8 is the prompt sentence and control parameters, and the output of Step 8 is raw response information containing generated problem text.

### Step 9:

The server parses and structures the response information into new problem information.

The server applies parsing rules to segment the generated text into individual problems, question texts, answer options, and markings of correct answers.

The server converts the segmented text into structured data fields and assigns identifiers and metadata such as difficulty level and topic label inferred from the prompt sentence.

The server stores the new problem information in the problem data store and marks it as generated content.

The input of Step 9 is the raw response information, and the output of Step 9 is structured new problem information integrated into the problem data store and available in memory.

### Step 10:

The server merges the filtered problem set from the database and the new problem information from the generative AI model.

The server creates a combined list that contains both preexisting problems and generated problems, and the server applies ordering rules to interleave or group them according to difficulty or topic.

The server ensures that the total number of problems does not exceed a configured limit and that coverage for weak topics is sufficient.

The input of Step 10 is the filtered problem set and the new problem information, and the output of Step 10 is a merged problem set prepared for presentation.

### Step 11:

The server transmits the merged problem set to the terminal for display.

The server serializes the merged problem set into a response message including problem texts, answer options, and metadata.

The terminal receives the response message, parses it, and renders the problems on the display using UI components such as text fields and selectable buttons.

The input of Step 11 is the merged problem set in the server memory, and the output of Step 11 is the displayed problem list on the terminal screen.

### Step 12:

The user reads the presented problems and submits answer information through the terminal.

The terminal records each selected option or typed answer and associates it with a corresponding problem identifier.

The terminal packages the collected responses into answer information, including timestamps and the user identifier, and transmits the answer information to the server.

The input of Step 12 is the displayed problem list and user interactions on the terminal, and the output of Step 12 is answer information sent to the server.

### Step 13:

The server evaluates the answer information to calculate updated comprehension indices.

The server retrieves correct answer data and difficulty values for each problem from the problem data store and compares the submitted answers with the correct answers.

The server marks each answer as correct, incorrect, or partially correct according to evaluation criterion information, and aggregates these marks over the set of problems to compute a new comprehension index for the learner on the relevant topic.

The server updates usage history information and evaluation result information in the learner data store.

The input of Step 13 is the answer information and stored problem information, and the output of Step 13 is updated comprehension indices and updated records in the learner data store.

### Step 14:

The server recomputes learner state information using the updated feature data.

The server regenerates a feature vector that incorporates the new comprehension indices and the latest usage history information.

The server inputs this updated feature vector into the machine learning algorithm and obtains a new learning level classification and updated topic-wise proficiency scores.

The server replaces or augments the previous learner state information with the new learner state information.

The input of Step 14 is the updated comprehension indices and usage history information, and the output of Step 14 is refreshed learner state information reflecting the most recent learner performance.

### Step 15:

The server calculates a learning progress degree and determines whether a notification should be generated.

The server analyzes changes in comprehension indices and learner state information over time to compute gradients or trends, and it summarizes these into a scalar or categorical learning progress degree.

The server compares the learning progress degree with predefined thresholds to detect stagnation, rapid improvement, or regression.

If a threshold condition is met, the server generates notification information including support request information or instructor intervention request information and transmits it to the terminal or the instructor terminal.

The input of Step 15 is historical and current learner state information and comprehension indices, and the output of Step 15 is a learning progress degree and, when applicable, notification information.

### Step 16:

The server generates visualization data representing the learner's state and progress and sends it to the terminal.

The server constructs time-series data structures for comprehension indices and learning progress degree, as well as topic-wise bars for proficiency.

The server formats these data structures into visualization data suitable for rendering graphs and charts on the terminal.

The terminal receives the visualization data and updates an interactive dashboard that allows the user and an instructor to inspect performance metrics and trends.

The input of Step 16 is the learner state information, comprehension indices, and learning progress degree, and the output of Step 16 is the visualization data and an updated interactive dashboard on the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented learning support systems typically retrieve fixed question items from a storage apparatus based on coarse-grained learner profiles and static difficulty labels. In such systems, the processor merely matches a selected topic with pre-registered problems and presents those problems to a learner terminal. Evaluation of answers is similarly limited to simple correctness checks against stored solutions, and the resulting scores are used only to update basic progress indicators such as completion percentages. As a result, these systems treat the learner's interaction history and performance data as passive records and do not exploit them as dynamic control signals for subsequent data processing within the system.

From the standpoint of computer technology, these limitations manifest as several technical shortcomings. First, the selection logic executed by the processor over the problem data set is typically shallow, relying on direct filtering by topic and static difficulty tags, without iterative refinement based on multi-dimensional performance signals such as error patterns, answer time, or recent difficulty trajectories. This leads to inefficient database utilization and suboptimal query behavior, in which large problem sets are scanned or fetched but not adaptively narrowed, increasing processing load and latency while failing to surface the most relevant data for a given learner state.

Second, conventional systems do not integrate generative AI models as programmable components of the learning pipeline in a technically structured manner. The prompt sentences, if used at all, are manually crafted and not systematically generated from internal system state such as comprehension indices, learning history vectors, and per-learner feature profiles. Consequently, the generative AI model operates as a loosely coupled content source rather than as a dynamically controlled computational resource. This deprives the system of the ability to use internal performance metrics to drive generation conditions (e.g., difficulty, format, and content domain) and to fill gaps in the problem data set in a targeted and efficient way.

Third, many existing platforms do not perform time-series analysis of learning progress at the system level. They do not treat learning logs as structured machine-processable streams to detect stagnation, performance degradation, or anomalous behavior requiring intervention. Instead, any alerts or notifications are often triggered manually or based on simplistic thresholds applied to isolated sessions. As a result, the system fails to exploit its accumulated log data to control server-side processes such as adaptive problem reselection, targeted alert generation, and dynamic prompt construction.

Fourth, learning level visualization is frequently implemented as static or periodically refreshed dashboards that do not provide interactive, real-time views of aggregated indicators such as progress degree, achievement degree, weak fields, and learning time. The processor does not systematically transform its internal metrics and notification outputs into visualization data structures optimized for dynamic rendering on different terminals. This leads to inefficiencies in how data is organized and delivered for front-end visualization and limits the ability of both learners and supporters to obtain timely and technically meaningful insight into the underlying system state.

Accordingly, there is a need for an improved computer-implemented learning support system in which a processor, operating with a storage apparatus and a learner terminal, (i) performs multi-stage, performance-aware search and filtering over a problem data set, (ii) programmatically constructs prompt sentences from internal comprehension indices and history information to control a generative AI model as a tightly coupled computational resource, (iii) executes time-series analysis of learning logs to generate targeted intervention notifications, and (iv) generates structured visualization data that can be consumed by interactive display components on learner and supporter terminals. Such a system should improve the technical functioning of the underlying data processing pipeline, including database querying, AI interaction, notification logic, and visualization data preparation, rather than merely implementing a new pedagogical workflow.

The specific processing by the specific processing unit 290 of the data processing device 12 in Application Example 1 is realized by the following means.

The present invention provides a server comprising a processor and a storage apparatus, the processor being configured to receive learning information and learner attribute information from a learner terminal and to execute a search process on a problem data set stored in the storage apparatus so as to extract problems associated with a plurality of difficulty levels and select, from the extracted problems, a problem group adapted to a learning level of a learner; to receive answer information from the learner terminal, evaluate the answer information based on the problem data set or evaluation criterion data stored in the storage apparatus, calculate a comprehension index for the learner based on an evaluation result, and store the comprehension index as learning history information in the storage apparatus; to generate, based on the comprehension index and the learning history information, a prompt sentence that instructs generation of learning support content including at least a learning plan, learning materials, and learning methods, input the prompt sentence into a generative AI model, and acquire the learning support content output from the generative AI model; to analyze a progress state of learning activities in a time series based on the learning history information and the comprehension index, detect learning stagnation or performance degradation according to a predetermined condition, and generate notification information including an intervention request or support guidance to be transmitted to at least one of the learner and a supporter; to perform a search process again on the problem data set based on at least one of the learning information, the comprehension index, and the learning history information, narrow down problem candidates by applying a filtering algorithm according to at least one of problem presentation history, correct answer rate, answer time, and difficulty level, and reselect an optimized problem group for the learner; to generate a prompt sentence representing problem generation conditions based on at least one of the learning information, the comprehension index, and a shortage state of the problem data set, input the prompt sentence into the generative AI model, cause the generative AI model to generate new problem data corresponding to a specified difficulty level, question format, and content domain, and integrate the new problem data into at least one of the problem data set and the problem group; and to generate server response data including at least the learning support content and the new problem data and transmit the server response data to the learner terminal so as to cause display control of the learner terminal to dynamically update at least a problem presentation screen and a feedback screen. This enables the underlying computer system to use internal performance metrics and history information to adapt database querying, AI-driven content generation, notification output, and visualization data preparation in real time, thereby improving the efficiency, responsiveness, and technical quality of the learning support processes executed by the processor.

The term “processor” refers to a hardware or virtual computation unit, such as a central processing unit or a programmable logic device, configured to execute instructions that implement the functions of receiving data, searching data sets, evaluating answers, generating prompt sentences, interacting with a generative AI model, and generating response data in the system.

The term “storage apparatus” refers to one or more computer-readable memory components, such as non-volatile storage or volatile memory, that store data including problem data sets, evaluation criterion data, comprehension indices, learning history information, and learning support content used and updated by the processor.

The term “learner terminal” refers to an information processing device operated by a learner, such as a portable terminal or a general-purpose computer, that transmits learning information and answer information to the server and displays problem presentation screens and feedback screens based on server response data.

The term “supporter terminal” refers to an information processing device operated by a supporter, such as an instructor or tutor, that receives visualization data and notification information from the server and displays information regarding learner progress, learning level, and intervention requests.

The term “learning information” refers to information related to a learning activity selected or specified by a learner, including at least a subject, a topic, a content domain, and optionally a desired difficulty level, time frame, or learning objective.

The term “learner attribute information” refers to profile information associated with a learner, including at least age, grade, prior knowledge level, preferred subject, or other characteristics used by the processor to adapt problem selection and content generation.

The term “problem data set” refers to a collection of problem records stored in the storage apparatus, each problem record including at least problem text, associated difficulty-level information, one or more correct answers, and optional metadata such as topic, subtopic, and content domain.

The term “difficulty level” refers to a classification value associated with a problem, such as an identifier representing relative complexity or required proficiency, including categories such as easy, medium, hard, or a numerical scale used for selection and filtering by the processor.

The term “problem group” refers to a subset of problems selected from the problem data set, the subset being composed of one or more problem records that the processor has determined to be appropriate for a current learning session or learner state.

The term “answer information” refers to electronic data representing a learner's responses to one or more problems, including at least a problem identifier, learner-entered answer content, and optionally associated metadata such as submission time or response duration.

The term “evaluation criterion data” refers to data defining rules or reference information used by the processor to evaluate correctness or quality of learner answers, including at least correct answer data, scoring rules, or rubrics for objective or subjective problems.

The term “evaluation result” refers to data computed by the processor from the answer information and the evaluation criterion data, including at least correctness flags, numerical scores, and optionally error-type classifications for each problem.

The term “comprehension index” refers to a numerical or categorical indicator that quantifies a learner's understanding in at least one subject, topic, or difficulty level, calculated from one or more evaluation results and used to control subsequent processing by the processor.

The term “learning history information” refers to structured records stored in the storage apparatus that represent past learning activities of a learner, including at least problem presentation history, answer information, evaluation results, comprehension indices, and time-series data.

The term “learning support content” refers to content generated or selected to support a learner's study, including at least a learning plan, recommended learning materials, and suggested learning methods, and optionally comments, explanations, or practice sequences tailored to the learner.

The term “prompt sentence” refers to a machine-readable instruction sequence, expressed as text or structured data, generated by the processor and supplied as input to a generative AI model, the instruction sequence specifying at least a desired output type, conditions, and constraints.

The term “generative AI model” refers to a trained computational model, such as a large-scale neural network, that receives a prompt sentence as input and outputs generated content including at least problem data, learning support content, or evaluation assistance according to the prompt.

The term “problem generation conditions” refers to a set of parameters included in or implied by a prompt sentence, indicating at least desired difficulty level, question format, content domain, and number of problems to be generated by the generative AI model.

The term “new problem data” refers to problem records, including at least generated problem text and associated solution information, that are produced by the generative AI model in response to a prompt sentence and integrated by the processor into the problem data set or problem group.

The term “search process” refers to processing executed by the processor on the problem data set or other stored data, including at least retrieval operations, filtering operations, and sorting operations based on keys such as topic, difficulty level, or learner-related metrics.

The term “filtering algorithm” refers to a computational procedure used by the processor to narrow down problem candidates, the procedure using at least problem presentation history, correct answer rate, answer time, difficulty level, or other learner-related indicators as selection criteria.

The term “problem presentation history” refers to data indicating which problems have been previously presented to a learner, including at least problem identifiers, presentation timestamps, and optionally associated session identifiers.

The term “correct answer rate” refers to a metric computed by the processor that represents a proportion of problems answered correctly by the learner within a defined scope, such as per topic, per difficulty level, or per session.

The term “answer time” refers to a measure of temporal duration associated with a learner's response to a problem, including at least an elapsed time between the display of the problem and submission of the answer.

The term “learning plan” refers to a structured arrangement of learning activities for a learner, including at least a sequence of topics, suggested durations, and recommended problem sets or materials over a predetermined period.

The term “learning materials” refers to digital resources for study, such as textual explanations, diagrams, practice questions, or external reference links, which may be specified or recommended within the learning support content.

The term “learning methods” refers to recommended strategies or procedures for study, such as review techniques, practice intervals, or suggested modes of engagement, which are included in the learning support content.

The term “progress state of learning activities” refers to a representation of how a learner's learning has evolved over time, including at least transitions in comprehension indices, number of completed problems, and changes in difficulty levels across sessions.

The term “learning stagnation” refers to a condition detected by the processor in which a learner's progress state indicates minimal or no improvement in comprehension indices or performance metrics over a defined time interval.

The term “performance degradation” refers to a condition detected by the processor in which evaluation results or comprehension indices for a learner decrease beyond a predetermined threshold relative to previous performance.

The term “notification information” refers to data generated by the processor to initiate communication regarding learner state, including at least an intervention request, support guidance, or alerts about detected learning stagnation or performance degradation.

The term “intervention request” refers to a component of notification information that prompts a supporter or system to take specific remedial actions, such as providing additional explanation, adjusting content difficulty, or contacting the learner.

The term “support guidance” refers to information included in notification information that indicates recommended support actions, such as targeted review topics, suggested problem types, or guidance messages to be communicated to the learner.

The term “server response data” refers to structured data generated by the processor and transmitted to a learner terminal or supporter terminal, including at least problem groups, learning support content, new problem data, and optionally visualization data.

The term “problem presentation screen” refers to a user interface screen displayed on the learner terminal that presents at least one problem to the learner and accepts input of answer information.

The term “feedback screen” refers to a user interface screen displayed on the learner terminal that presents at least evaluation results, explanations, or learning support content in response to completed problem attempts.

The term “visualization data” refers to aggregated and structured data prepared by the processor for graphical or tabular display, including at least progress degree, achievement degree, weak fields, and learning time per learner.

The term “progress degree” refers to an indicator, computed by the processor, representing the extent to which a learner has advanced through assigned topics or problem sets over a defined period.

The term “achievement degree” refers to an indicator, computed by the processor, representing the level of attainment by a learner, such as an aggregated score or mastery level across topics or difficulty levels.

The term “weak field” refers to a subject area, topic, or skill in which a learner's comprehension index or performance metrics are below one or more thresholds relative to other areas.

The term “interactive display screen” refers to a user interface screen that is configured to update its displayed contents in response to user operations or display update requests, such as filtering, time-range selection, or drill-down into detailed performance information.

The term “display update request” refers to an operation or event that triggers the processor or terminal to refresh or modify the contents of a display screen, such as a user selection, a navigation command, or receipt of new server response data.

In one embodiment, a server cooperates with one or more terminals operated by users to implement a computer-implemented learning support system. The server includes a processor, a main memory, a non-volatile storage apparatus, and a network interface. The terminal includes a display unit, an input unit such as a touch panel or keyboard, a local memory, and a communication interface. The server and the terminal communicate over a communication network such as the Internet using a secure transport protocol.

The server uses an operating system such as a general-purpose server operating system and executes server-side application software that implements the functions described in the claims. The server uses a database management system to realize the storage apparatus, for example, a cloud-hosted document-oriented database. The terminal uses an execution environment such as a mobile application framework to implement a user interface and network communication logic.

The server stores, in the storage apparatus, a problem data set, evaluation criterion data, learner profiles, learning history information, model configuration data for a generative AI model, and visualization data structures. The problem data set is stored as records, each record including fields for a problem identifier, problem text, one or more correct answers, difficulty level metadata, topic identifiers, subtopic identifiers, and content domain identifiers. The storage apparatus stores indexed collections to enable efficient query execution by the processor. For example, the problem data set is indexed by topic, difficulty, and historical usage count.

The server maintains learner attribute information in a profile data structure containing at least a learner identifier, age group, grade level, language settings, and preferred subjects. The server maintains learning history information in a time-series data structure, in which each entry includes a session identifier, problem identifiers presented during the session, timestamps of presentation and answer submission, answer content, evaluation results, comprehension indices, and derived metrics such as correct answer rate and answer time. The terminal executes a client application that displays a user interface for selecting learning information, answering problems, and viewing feedback. The terminal sends learning information, such as selected subject and topic, and learner attribute information, such as grade level and language preference, to the server via the communication interface. The terminal receives server response data including problem groups, new problem data, learning support content, and visualization data, and renders problem presentation screens and feedback screens by using display components such as text rendering components and chart rendering components.

The server uses a generative AI model implemented as a parameterized neural network deployed on one or more computing devices. In one embodiment, the generative AI model is a transformer-based neural network with multiple self-attention layers, feedforward layers, and positional encoding. The server stores model parameters (weights and biases) in a model storage region and accesses the generative AI model via an inference engine that accepts input token sequences corresponding to prompt sentences and outputs token sequences corresponding to generated content.

The server generates a prompt sentence as a structured natural language instruction for the generative AI model. The server constructs the prompt sentence by concatenating fixed template phrases with variable parts derived from internal data structures, such as comprehension indices, learning history vectors, topic identifiers, and desired difficulty levels. For example, the server may generate a prompt sentence in the following form:

“Generate 5 multiple-choice questions about ‘Medieval Europe’ for a learner at approximately 8th grade level. Use a mixture of easy and medium difficulty. For each question, provide one correct option and three distractor options, and indicate which option is correct and why.”

The server may also generate a prompt sentence for feedback generation, such as:

“Based on the following performance summary: ‘The learner correctly answered 3 out of 5 basic timeline questions about Medieval Europe but confused the order of key events and needed more than 90 seconds for most questions,’ propose a 7-day study plan including daily tasks, recommended materials, and brief explanations suitable for a junior high school learner.”

The server may further generate a prompt sentence for subjective evaluation, such as:

“Evaluate the correctness and completeness of the following learner answer. Question: ‘Explain the relationship between lords and vassals in Medieval Europe.’ Model answer: ‘Lords granted land to vassals in exchange for military service and loyalty.’ Learner answer: ‘Vassals helped lords in wars and protected their land.’ Provide a score from 0.0 to 1.0 and a one-sentence justification.”

The server tokenizes the prompt sentence into subword units using a predefined tokenizer and encodes the tokenized sequence as numerical vectors. The generative AI model processes the token vectors using multi-head self-attention mechanisms to derive context-aware representations and uses learned parameters to compute probability distributions over possible output tokens at each position. The inference engine performs an auto-regressive decoding procedure, for example by greedy decoding or beam search, to generate an output sequence that the server decodes back into text. The server then parses the generated text according to expected patterns defined in the prompt sentence template, such as the number of questions, answer labels, and explanation fields.

The server computes comprehension indices using numerical operations over evaluation results and learning history information. The server aggregates scores by topic and difficulty level, calculates moving averages, and applies threshold-based classification to assign a discrete comprehension level (for example, low, medium, high) to each content domain. The server stores these indices as part of the learning history information. By maintaining these indices as first-class data structures, the server can reuse them as input features for subsequent processing, including prompt sentence generation and filtering of problem candidates.

The server applies a filtering algorithm to narrow down problem candidates from the problem data set. The server represents problem presentation history as a vector of problem identifiers with associated counts and timestamps. The server represents correct answer rate per problem as a floating point value, and answer time as a recorded duration. The filtering algorithm uses these values as selection criteria to exclude, for example, problems that have been answered correctly several times by the same learner within a short period, or problems with answer times significantly below a threshold indicative of insufficient challenge. The server uses a scoring function that combines difficulty level, recent comprehension indices, and presentation history to assign a relevance score to each candidate problem, and sorts candidates according to this score. By doing so, the server improves data management and reduces unnecessary retrieval and transmission of low-relevance problems, thereby reducing communication load and storage access overhead.

The server uses the generative AI model not as a generic content generator but as a controlled computational module whose behavior is parameterized by internal state variables. For example, the server encodes the learner's weak field as text in the prompt sentence, such as “focus more questions on chronology of events than on definitions.” The server uses derived statistics, such as variance of scores across subtopics, as triggers to specify particular generation conditions. This integration allows the server to fill gaps in the problem data set in a targeted manner, such as generating intermediate-difficulty problems for underrepresented subtopics, rather than blindly expanding the database.

The server implements a specific data flow from answer information to comprehension indices to prompt sentence construction to generative AI model output. The server stores answer information in a normalized format, performs batch evaluation using vectorized comparison operations, and updates comprehension indices using incremental formulas such as exponentially weighted moving averages. The server then maps comprehension index ranges to textual descriptors inserted into the prompt sentences. For example, if the comprehension index on a topic is between 0.4 and 0.6, the server may insert “slightly above the learner's current level” into the prompt sentence. This mapping is implemented according to rules stored in the storage apparatus and executed by the processor, and it constitutes a deterministic algorithm that translates internal numeric state into natural language instructions for the generative AI model.

The server executes time-series analysis of learning history information to detect learning stagnation and performance degradation. The server represents the sequence of comprehension indices as a time-series vector for each topic, and computes derived metrics such as slope and variance over a sliding time window. If the slope falls below a negative threshold or remains near zero while problem difficulty remains constant or increases slightly, the server flags potential stagnation. Over a defined interval, the server may detect patterns such as repeated performance drops after difficulty changes. When such patterns are detected, the server generates notification information including intervention requests or support guidance. The server formats this notification information as structured messages and stores them in a notification queue, from which they are delivered to learner terminals and supporter terminals.

The server generates visualization data by aggregating comprehension indices, correct answer rates, problem counts, and learning time across sessions. The server converts these metrics into data structures suited for graphical rendering, such as arrays of (timestamp, score) pairs, histograms of difficulty levels, and topic-wise heatmaps. The server sends these data structures in server response data to the terminal, which renders them using chart components. By pre-aggregating and formatting data on the server, the system reduces computational load on terminals, optimizes network bandwidth usage, and ensures consistent representation of learning levels across different terminals.

The server uses the described architecture and processing pipeline to improve computer technology in several ways. First, by combining multi-stage query filtering in the problem data set with dynamic generation of problem data using the generative AI model, the server reduces query volume and storage operations required to obtain suitable problems, which contributes to improvement of processing speed and reduction of resource consumption.

Second, by representing comprehension indices and learning history information as explicit features and embedding them into prompt sentences, the server forms a closed feedback loop between evaluation and content generation that is not realizable by simple human-designed or static templates. This feedback loop enables the generative AI model to produce content that is adjusted at a finer granularity to the learner's actual performance, improving accuracy of problem difficulty alignment and reducing the need for repeated manual adjustments.

Third, by performing time-series analysis and generating structured visualization data on the server, the system converts raw log data into technically meaningful and compact data structures before transmission, thus reducing communication load and enabling faster rendering on the terminal. The use of feature extraction and aggregation on the server side also improves robustness against intermittent connectivity or limited processing power on learner terminals.

Fourth, the generative AI model is trained using a supervised learning method with a corpus of educational texts and problem-answer pairs. The server uses a loss function such as cross-entropy over token sequences, and an optimization algorithm such as stochastic gradient descent with adaptive learning rate to update model weights during a pre-deployment training phase. The server may perform fine-tuning of the generative AI model on anonymized historical problems and feedback data stored in the storage apparatus. The server may apply data augmentation techniques, such as paraphrasing questions or perturbing problem orders, to increase diversity of training examples. During inference, the server sets parameters such as temperature, top-k sampling, and maximum output length to control the balance between diversity and reliability of generated content. These specific details demonstrate that the use of the generative AI model goes beyond a generic “AI processing” and relies on particular network architectures, loss functions, and hyperparameters.

The server implements a modular software architecture in which different functional modules correspond to distinct computational tasks. A problem-selection module performs database access, filtering, and scoring of problem candidates. An evaluation module computes correctness and comprehension indices. A prompt-generation module constructs prompt sentences by merging template segments and variable segments derived from internal state. An AI-interaction module manages tokenization, inference requests, and parsing of AI outputs. A visualization module aggregates metrics and constructs visualization data structures. The modules communicate via well-defined data structures, such as JSON-like internal objects or equivalent in-memory representations, which specify fields for learner identifiers, problem identifiers, comprehension indices, and generation conditions. This modular design allows each part to be optimized separately for performance and accuracy. The server operates with non-conventional rules and processing flows that differ from straightforward automation of human tasks. For example, a human tutor may choose problems based on subjective assessments, whereas the server uses algorithmic ranking based on explicit features such as comprehension index, difficulty level, answer time, and presentation frequency. The server performs computations that would be impractical or impossible to perform reliably and consistently by a human in real time, such as maintaining and updating high-dimensional feature vectors for each learner, executing time-series analyses over large logs, and generating context-conditioned problems via high-parameter-count neural networks. By doing so, the system improves technical aspects of data processing, including query optimization, scoring, and feature-driven adaptive generation.

In another embodiment, the server may use a different type of generative AI model, such as a sequence-to-sequence recurrent neural network or a hybrid model that combines rule-based templates with neural generation for specific segments of the output. The server may replace the transformer-based architecture with a lightweight variant optimized for edge deployment, or use a distributed inference engine that spreads computation over multiple machines to handle higher throughput. The terminal may be implemented as a web application running in a browser, a native mobile application, or a desktop application, provided that it can send and receive structured data and render interactive display screens.

In still another embodiment, the server may adapt the prompt sentence templates according to language preferences and regulatory requirements, or may adjust the evaluation and notification thresholds according to institution-specific policies. The filtering algorithm may be modified to include additional features such as learner engagement metrics (for example, frequency of voluntary practice sessions) or predictive scores derived from additional machine learning models trained on learning history information.

By combining these embodiments, the system enables the processor to operate not merely as a conventional controller of display sequences but as an adaptive coordinator of multiple computational resources, including structured databases and generative AI models, with explicit feature extraction, prompt construction, and feedback loops. This results in improved precision of problem selection, faster adaptation of learning content, reduced database and network overhead, and enhanced robustness of visualization and notification functions.

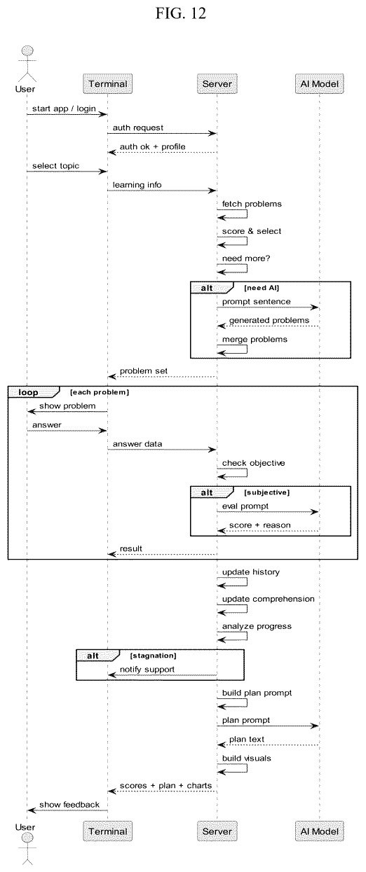

The following describes the processing flow using FIG. 12.

### Step 1:

Server initializes system resources and loads configuration data.

Server uses an operating system and server application software to start a learning support service.

Input: configuration files including database connection parameters, generative AI model endpoint information, prompt sentence templates, and logging settings.

Server reads the configuration files from the storage apparatus, parses key-value pairs, and stores them in memory as internal configuration objects.

Server initializes connections to a database management system (for example, a document-oriented database), sets up indices on problem data sets, and initializes an API client for communicating with a generative AI model endpoint.

Output: initialized in-memory configuration objects, active database connections, and an active AI model interface ready for subsequent requests.

### Step 2:

Terminal starts a client application and authenticates a user.

Terminal executes an application framework to display an initial login or profile screen.

Input: user credential information or authentication tokens entered or held by the terminal.

Terminal sends authentication data to the server over a secure communication channel.

Output: authentication request message transmitted to the server, containing user identifiers and credentials.

### Step 3:

Server authenticates the user and loads learner profile data.

Server receives the authentication request from the terminal and verifies credentials using an authentication service or internal user database.

Input: authentication request message including user identifiers and credential data.

Server compares received credentials with stored authentication records, generates a session token upon successful login, and queries the storage apparatus to retrieve the learner's profile, including grade, preferred subjects, and language settings.

Server constructs a profile object and attaches the session token.

Output: authentication response including session token and learner profile data, transmitted back to the terminal.

### Step 4:

Terminal displays a learning information selection interface.

Terminal renders a list of available subjects, topics, and difficulty options based on the learner profile received from the server.

Input: learner profile data and configuration parameters indicating available subject domains.

Terminal constructs a user interface layout with selectable elements (e.g., buttons or list items) for each subject and topic.

Output: on-screen display of selectable learning information, and internal UI state indicating available options.

### Step 5:

User selects learning information and initiates a learning session.

User operates the terminal to choose at least one subject, topic, and optionally an initial difficulty level.

Input: on-screen selection interface displayed by the terminal.

User taps or clicks desired items and confirms the selection by an action such as pressing a “Start Learning” button.

Output: selection events captured by the terminal, representing chosen subject, topic, and optional difficulty level.

### Step 6:

Terminal sends selected learning information and learner attributes to the server.

Terminal gathers the user's selections and associated learner attributes from local storage or the latest profile.

Input: user selection events and locally stored learner attributes.

Terminal packages subject, topic, difficulty preference, language preference, and learner identifier into a structured data message and transmits this message to the server using a network protocol.

Output: learning information request message sent to the server, representing the start of a new learning session.

### Step 7:

Server records the learning session and retrieves initial problem candidates from the database.

Server receives the learning information request and creates a new session record in the storage apparatus.

Input: learning information request message containing learner identifier, subject, topic, and optional difficulty.

Server writes a session entry with a timestamp, subject, topic, and default status values.

Server queries the problem data set using filters for subject and topic, and optionally a difficulty range, and retrieves a list of problem records.

Server performs basic filtering to ensure that each record includes required fields (problem text, correct answer, difficulty, and topic identifiers).

Output: a list of initial problem candidates and an updated session record stored in the database.

### Step 8:

Server calculates a relevance score for each problem candidate based on prior history.

Server obtains learning history information for the learner, including problem presentation history, correct answer rates, and average answer times.

Input: initial list of problem candidates and learning history information for the learner.

Server computes, for each candidate, a feature vector including difficulty level, number of previous presentations to this learner, historical correctness for this problem, and average answer time.

Server applies a scoring function that combines these features, for example by assigning weighted coefficients to each feature and summing them to produce a relevance score.

Output: scored list of problem candidates, each annotated with a relevance score and feature vector.

### Step 9:

Server selects a preliminary problem group adapted to the learner's level.

Server sorts the scored problem candidates in descending order of relevance score.

Input: scored list of problem candidates.

Server selects a subset of problems that satisfy constraints such as a target number of problems, a balanced distribution of difficulty levels, and exclusion of overused problems (e.g., problems already answered correctly multiple times recently).

Server stores the selected preliminary problem group in the session record.

Output: preliminary problem group tailored to the learner, ready for possible augmentation by the generative AI model.

### Step 10:

Server evaluates the sufficiency of the problem data and decides whether to invoke the generative AI model.

Server compares the number and difficulty distribution of problems in the preliminary problem group with thresholds defined in configuration data.

Input: preliminary problem group and configuration thresholds indicating minimal desired variety and coverage.

Server detects gaps, such as too few medium-level problems or lack of questions targeting a weak subtopic identified in the learner's history.

If gaps are detected, server sets a flag indicating that additional problems must be generated.

Output: decision flag specifying whether to call the generative AI model and a set of problem generation conditions describing the missing content.

### Step 11:

Server generates a prompt sentence specifying problem generation conditions.

Server takes as input the learner's comprehension indices for the selected topic, recent evaluation results, and the identified gaps in the current problem set.

Input: comprehension indices, recent scores, and problem generation conditions (e.g., number of problems, desired difficulty, and focus subtopic).

Server maps numeric indices to descriptive phrases, such as “slightly above the learner's current level” or “focus on timeline understanding of key events.”

Server inserts these phrases, along with explicit requirements on the number of problems, question format (e.g., multiple-choice, short answer), and content domain, into a text template to form a prompt sentence such as:

“Generate 5 short-answer questions about Medieval Europe focusing on the chronology of major events, at a difficulty slightly above the learner's current level. Provide each question, a model answer, and a one-sentence explanation.”

Output: fully constructed prompt sentence ready for use as input to the generative AI model.

### Step 12:

Server sends the prompt sentence to the generative AI model and obtains generated problems.

Server converts the prompt sentence into tokens and invokes the AI inference engine using an API or internal function call.

Input: prompt sentence and model configuration parameters such as maximum output length and decoding strategy.

Server executes the generative AI model, which processes the tokens through neural network layers (e.g., self-attention and feedforward layers), and decodes an output text sequence representing generated problems.

Server receives the output text, parses it according to expected delimiters and patterns (e.g., numbering of questions, explicit “Answer:” and “Explanation:” labels), and creates a set of problem objects, each with problem text, answer, and explanation fields.

Output: new problem data set generated by the generative AI model, structured as problem objects with associated metadata.

### Step 13:

Server integrates the generated problems into the existing problem group.

Server merges the AI-generated problems with the preliminary problem group while maintaining uniqueness and desired difficulty distribution.

Input: preliminary problem group and new problem data set from the generative AI model.

Server assigns identifiers to each generated problem, sets origin metadata (e.g., “AI-generated”), and re-computes difficulty labels if necessary based on instructions contained in the prompt sentence.

Server recomputes a relevance score for all problems, including generated ones, and reorders them to maximize pedagogical progression while respecting technical constraints like limiting redundancy.

Output: finalized problem group for the current session, containing both database-retrieved and AI-generated problems with consistent structure.

### Step 14:

Server packages the finalized problem group and related session metadata into server response data.

Server creates a structured response object that includes the list of problems, each problem's identifier, text, answer type (e.g., multiple-choice or free text), and difficulty, along with session identifiers and timing recommendations.

Input: finalized problem group and session record.

Server serializes the response object into a network-transmissible format and adds necessary headers or metadata for integrity checking.

Output: server response data encapsulating the problem group and session parameters, prepared for transmission to the terminal.

### Step 15:

Terminal receives the server response data and prepares the problem presentation screen.

Terminal parses the received data into internal objects, storing the problems in local memory for access during the session.

Input: server response data including the problem group and session metadata.

Terminal updates its internal state to track the current problem index, remaining problem count, and any session constraints such as time limits.

Terminal renders the first problem on the display, including question text, input widgets (e.g., text field or multiple-choice options), and navigation controls such as “Submit” and “Next” buttons.

Output: displayed problem presentation screen and initialized client-side session state.

### Step 16:

User reads and answers the problems presented on the terminal.

User interprets the question text displayed on the screen and interacts with input components to provide answers.

Input: problem text and answer input controls on the terminal display.

User types in a response, selects one or more options, or performs another appropriate input action and confirms submission by pressing a designated button.

Output: raw answer data captured by the terminal, associated with the corresponding problem identifier and timestamp.

### Step 17:

Terminal transmits answer information to the server.

Terminal records the user's answer, the problem identifier, and the submission timestamp in local memory.

Input: raw answer data and associated problem identifiers from the user's interaction.

Terminal constructs an answer message including session identifier, problem identifier, answer content, and local timing data.

Terminal sends the answer message to the server using a reliable communication protocol.

Output: answer information message delivered to the server for evaluation.

### Step 18:

Server evaluates objective answers and computes evaluation results.

Server receives the answer message and matches the problem identifier with the corresponding record in the problem group or global problem data set.

Input: answer information message and stored problem records containing correct answers.

Server compares the user's answer with the correct answer, optionally performing normalization such as trimming whitespace, ignoring case differences, or mapping synonyms.

Server marks each answer as correct or incorrect, and computes a numerical score (e.g., 1 for correct, 0 for incorrect, or partial credit if applicable).

Output: evaluation results per problem, including correctness flags and scores.

### Step 19:

Server optionally uses the generative AI model to assist in evaluating subjective answers.

Server detects problems marked as subjective, such as free-text explanation questions, and builds a prompt sentence containing the question, a reference model answer, and the user's answer.

Input: subjective answer content, question text, and reference answer text.

Server constructs a prompt sentence such as:

“Evaluate the following learner answer. Question: ‘Explain the relationship between lords and vassals in Medieval Europe.’ Model answer: ‘Lords granted land to vassals in exchange for military service and loyalty.’ Learner answer: ‘Vassals protected the land and fought in wars for the lords.’ Provide a score from 0.0 to 1.0 and a brief justification.”

Server sends this prompt sentence to the generative AI model, receives an evaluation text including a score and justification, parses the score as a numeric value, and attaches the justification as part of the evaluation result.

Output: augmented evaluation results for subjective problems, including AI-assisted scores and explanations.

### Step 20:

Server updates comprehension indices and learning history information based on evaluation results.

Server aggregates problem-level scores for the current session and updates topic- and difficulty-specific metrics.

Input: evaluation results and existing comprehension indices and learning history records.

Server applies mathematical operations such as averaging scores across problems, computing weighted updates using exponential decay factors for prior sessions, and recalculating per-topic comprehension indices.

Server writes updated comprehension indices and a new history entry for the session, including timestamps, problem identifiers, scores, and derived metrics, into the storage apparatus.

Output: updated comprehension indices and learning history records stored in the database.

### Step 21:

Server generates a prompt sentence for learning support content based on updated comprehension indices.

Server reads new comprehension indices and performance summaries across subtopics, identifying weak fields and strong fields.

Input: updated comprehension indices and aggregated performance statistics.

Server inserts descriptive phrases into a template, such as “The learner is strong in basic definitions of feudalism but weak in the chronology of events” and requests a plan.

For example, the server may generate:

“Based on the following learner profile and performance: ‘Strong in basic definitions of feudalism, weak in chronology of Medieval European events, average response time 80 seconds per question,’ propose a 7-day learning plan with daily activities, recommended resources, and short explanations suitable for a middle school learner.”

Output: prompt sentence specifying conditions for generating learning support content, ready to be submitted to the generative AI model.

### Step 22:

Server obtains learning support content from the generative AI model.

Server submits the prompt sentence to the generative AI model using the AI interaction module and receives a generated text describing a learning plan, recommended materials, and learning methods.

Input: learning-support prompt sentence and model configuration parameters.

Server decodes and parses the generated content into structured fields such as daily tasks, resource descriptions, and study tips, and checks for consistency (e.g., sequence of days, reasonable workload).

Output: structured learning support content tailored to the learner's current comprehension indices.

### Step 23:

Server analyzes time-series learning history to detect stagnation or performance degradation.

Server retrieves a sequence of comprehension indices and related metrics over a predetermined time window.

Input: time-series learning history including session dates, comprehension indices, and difficulty level progression.

Server calculates slopes of comprehension indices across sessions, detects plateaus or declines beyond thresholds, and correlates these patterns with difficulty changes and answer times.

If the analysis reveals stagnation or degradation, server creates notification information including an intervention request and support guidance, such as “Recommend instructor review; learner's performance has declined after introducing advanced timeline questions.”

Output: notification information records containing intervention requests and guidance to be sent to learner and supporter terminals.

### Step 24:

Server generates visualization data for terminals.

Server aggregates metrics like progress degree, achievement degree, weak fields, and total learning time, and organizes them into data structures for charts and tables.

Input: updated comprehension indices, evaluation statistics, and time-series learning history.

Server produces arrays of time-value pairs, distributions of difficulty levels, and topic-based summaries, and labels them with human-readable descriptors for use in visual elements.

Output: visualization data sets suitable for rendering on an interactive display screen.

Server sends evaluation results, learning support content, notification information, and visualization data to the terminal.

Server composes a comprehensive response that includes problem-by-problem feedback, overall scores, the generated learning plan, any detected alerts, and visualization-ready metrics.

Input: evaluation results, learning support content, notification information, and visualization data.

Server serializes this information into a structured message and transmits it to the terminal over the network.

Output: enriched server response data delivered to the terminal for presentation to the user and any supporter.

### Step 26:

Terminal displays feedback, plan, notifications, and visualizations to the user.

Terminal parses the received data and updates multiple screens, including a feedback screen, a plan overview screen, and a progress visualization screen.

Input: enriched server response data containing scores, explanations, plan content, notifications, and visualization data.

Terminal renders textual feedback next to each previously answered problem, displays the 7-day plan with daily tasks, shows alerts indicating recommended intervention or suggested review areas, and generates charts showing progress over time.

Output: updated user interface enabling the user to understand performance, follow the plan, and optionally request additional support.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented learning support systems typically retrieve static problems from a storage apparatus and present them to a learner through a terminal. In such systems, the problem selection logic, scoring logic, and feedback logic are often hard-coded and separated from external intelligent components. As a result, the systems have limited capability to adapt the content and structure of learning tasks to a learner's current understanding level in real time, to generate new problems beyond a fixed problem set, or to generate personalized learning plans without extensive manual authoring.

Moreover, in many existing systems, the processing pipeline from problem generation to evaluation and feedback is not tightly integrated with a generative AI model. When external AI services are used, they are often invoked in an ad-hoc manner, for example, to provide single answers or explanations. The underlying computational platform does not manage prompt design, result parsing, adaptive re-prompting, and iterative refinement as a unified, automated process. This leads to inefficiencies such as redundant network calls, inconsistent problem formats, and fragile parsing logic that must be manually adjusted for each use case, thereby increasing computational overhead and reducing system robustness.

Further, existing architectures typically treat the learner's responses and performance metrics as simple outcome data for reporting, rather than as first-class computational inputs that drive subsequent problem generation. In such architectures, the processor does not systematically transform numeric performance data (e.g., correct answer rate) into structured prompt sentences to control the behavior of a generative AI model. Consequently, the system cannot fully exploit the generative AI model as a dynamic content generator that is programmatically steered by real-time learner metrics.

In addition, conventional systems often lack an integrated mechanism for generating machine-processable, structured visualization control data that links time-series performance data with interactive dashboards. Visualization layers are usually implemented as separate components with their own logic and data formats, resulting in duplicated data transformations, latency in updating learner progress views, and difficulty in ensuring that the dashboards accurately reflect the current internal state of the learning engine.

Accordingly, there is a need for an improved computer-implemented learning support system and an associated server that (i) programmatically generates and manages prompt sentences to a generative AI model based on learner-specific performance data and learning history, (ii) automatically parses and normalizes AI-generated problem data into a predetermined data structure suitable for online testing, (iii) computes understanding levels and feedback in a form that directly drives subsequent AI calls, and (iv) produces structured display control information for interactive, real-time visualization of learning progress, thereby improving the overall efficiency, scalability, and reliability of the learning support platform as a computer technology.

The specific processing by the specific processing unit 290 of the data processing device 12 in Example 2 is realized by the following means.

The present invention provides a server comprising a processor configured to accept, via a terminal, an operation in which a user selects learning target information and problem conditions; generate, based on the learning target information and the problem conditions, a prompt sentence for input to a generative AI model by performing character string processing, and transmit request data including the prompt sentence to the generative AI model via a communication path; acquire problem information generated by the generative AI model on the basis of the prompt sentence, and analyze the problem information into a predetermined data structure to extract each question, each choice, and correct answer information; generate, based on the extracted problem information, screen data for an online test by using a markup language and a scripting language, and distribute the screen data to the terminal; acquire answer data of the user transmitted from the terminal, compare the answer data with the correct answer information to determine correctness or incorrectness for each question, and calculate a number of correct answers and a correct answer rate by performing arithmetic operations; classify a level of understanding into a plurality of stages on the basis of the calculated correct answer rate, and generate feedback information according to a result of the classification; dynamically generate, on the basis of the level of understanding and learning history information, a prompt sentence for additional learning problem generation or learning plan proposal, and input the prompt sentence to the generative AI model to acquire supplementary problems or a learning plan proposal; and transmit the level of understanding, the feedback information, and the supplementary problems or the learning plan proposal to the terminal, and generate display control information for visually displaying a learning level by storing learning progress in a time-series manner. This enables the server to implement an integrated computational pipeline in which learner interactions and performance metrics are converted into structured prompt sentences that programmatically control the generative AI model, normalize the resulting AI-generated content into a consistent data structure for online testing, and continuously update both adaptive learning content and interactive visualizations, thereby improving the technical performance, adaptability, and robustness of the computer-based learning support system.

The term “processor” refers to a hardware or virtual computation unit, such as a central processing unit or a processing core, configured to execute instructions of a program to perform the described functions of the system.

The term “terminal” refers to an information processing apparatus, such as a personal computer, a tablet device, or a smartphone, that communicates with the server, displays screens to a user, and transmits input operations and answer data to the server.

The term “user” refers to a human operator, including a learner or an instructor, who interacts with the terminal to select learning target information, answer problems, and view feedback and visualizations.

The term “learning target information” refers to information indicating a subject, topic, domain, or concept to be studied by the user, including, for example, classification data specifying an academic field, a unit, a difficulty level, or a problem count.

The term “problem conditions” refers to parameter information that defines requirements for generated problems, including at least one of a number of questions, a difficulty level, a problem format, a topic range, or a question type.

The term “generative AI model” refers to a software-implemented artificial intelligence model configured to generate output data, such as natural language text, in response to an input prompt sentence, using machine learning techniques such as deep learning.

The term “prompt sentence” refers to a text string or structured textual instruction that is input to the generative AI model to specify a desired output, including constraints on content, format, difficulty, and quantity of generated problems or learning plans.

The term “request data” refers to structured data, including at least the prompt sentence and associated control parameters, that is transmitted from the server to the generative AI model via a communication path for the purpose of requesting content generation.

The term “problem information” refers to data generated by the generative AI model in response to the prompt sentence, the data including at least one question text, one or more option texts, and information indicating a correct answer.

The term “predetermined data structure” refers to a predefined format for representing problem information inside the server, such as an arrangement of fields or records specifying a question, options, and a correct answer index, which is used for consistent processing and storage.

The term “question” refers to a unit of problem information that presents a task, query, or statement for which the user is requested to select an answer or input a response.

The term “choice” refers to one of multiple selectable answer candidates associated with a question, from which the user selects at least one as an answer in a multiple-choice format.

The term “correct answer information” refers to data indicating which choice or response is designated as correct for a given question in the problem information.

The term “screen data” refers to data describing a user interface for an online test, generated using a markup language and a scripting language, and including layout, text, and interactive controls for presenting questions and receiving user answers.

The term “markup language” refers to a structured description language, such as a hypertext markup language, used to define the layout, structure, and content of screen data for display on the terminal.

The term “scripting language” refers to a program description language, such as a client-side scripting language, used to implement dynamic behavior, event handling, and logic for online tests and visualizations on the terminal.

The term “online test” refers to a test or assessment that is delivered and executed through a network-connected terminal, in which questions are displayed on a screen and the user inputs answers electronically.

The term “answer data” refers to data transmitted from the terminal to the server, the data indicating the user's selected choices or responses for the questions presented in the online test.

The term “arithmetic operations” refers to numerical computations, including at least addition, division, and percentage calculation, performed by the processor to derive values such as a number of correct answers and a correct answer rate.

The term “number of correct answers” refers to a numerical value indicating how many questions in the online test have been answered correctly by the user based on comparison with the correct answer information.

The term “correct answer rate” refers to a numerical value representing a ratio or percentage of correct answers, obtained by dividing the number of correct answers by a total number of questions and optionally multiplying by a constant.

The term “level of understanding” refers to a classification result indicating the user's degree of mastery of the learning target information, categorized into a plurality of stages such as high, medium, or low based on the correct answer rate or related metrics.

The term “feedback information” refers to information generated by the processor that provides the user with an explanation, evaluation, recommendation, or guidance according to the level of understanding.

The term “learning history information” refers to accumulated data about a user's past learning activities, including at least one of past test results, topics studied, time stamps, correctness patterns, and previously generated learning plans.

The term “additional learning problem generation” refers to processing in which new problems are generated, using the generative AI model, in order to further train or remediate the user based on the current level of understanding and learning history information.

The term “learning plan proposal” refers to information indicating a recommended sequence or schedule of learning activities, topics, materials, or methods tailored to the user's level of understanding and learning history information.

The term “supplementary problems” refers to additional problems generated after an initial assessment, which are designed to reinforce, remediate, or extend the user's learning in relation to the learning target information.

The term “learning plan proposal” (when used in contrast to supplementary problems) refers to a set of structured recommendations output by the generative AI model that direct future learning steps rather than immediate problem solving.

The term “display control information” refers to data generated by the processor that specifies how learning levels, performance metrics, and time-series results are to be visually represented on the terminal, including layout, chart type, and update behavior.

The term “learning progress” refers to a temporal evolution of the user's performance and activities, including changes in correct answer rates, levels of understanding, and completed tests over time.

The term “time-series manner” refers to a storage or representation format in which learning progress data is recorded with associated time information, such as time stamps or sequential identifiers, allowing chronological analysis and visualization.

The term “learning level” refers to a status indicator of the user's current state of knowledge or skill in the learning target information, which may be derived from one or more levels of understanding, correct answer rates, and historical performance.

The term “interactive dashboard” refers to a user interface component that visually presents learning levels, correct answer rates, and chronological test results, and that supports user interaction such as filtering, hovering, or selecting data elements, while providing real-time or near real-time updates based on new display control information.

The term “data update function” refers to a capability of the interactive dashboard to receive updated structured data from the server and modify displayed visual elements without requiring a complete reload of the entire user interface.

The term “structured data” refers to data organized in a machine-readable format, such as records, arrays, or objects with defined fields, suitable for direct use in generating or updating visualizations on the dashboard.

The term “drawing control data” refers to parameter information, such as chart types, axes, labels, scales, and color settings, that controls how the structured data is graphically rendered by a visualization component on the terminal.

In one embodiment, a server, a terminal, and a user cooperate to implement a computer-implemented learning support system that dynamically generates problems and learning plans using a generative AI model. The server is realized by one or more information processing devices including at least a processor, a main memory, a non-volatile storage device, a network interface, and optionally a graphics processing unit. The processor executes a server-side program stored in the non-volatile storage device and loaded into the main memory. The terminal is realized by an information processing apparatus, such as a personal computer, a tablet device, or a smartphone, including a processor, a memory, a display, and input devices. The user operates the terminal to select learning target information, answer generated problems, and review feedback and visualizations.

The server executes an application program implemented using, for example, a server-side framework based on a general-purpose programming language. The server uses a storage apparatus implementing a relational or document-oriented database to maintain user accounts, learning history information, and generated problem sets. The server further communicates with an external generative AI model via a communication network such as the Internet using a network protocol. The generative AI model is implemented as a neural network-based text generation model, for example a transformer-type deep neural network running on a computing infrastructure equipped with graphics processing units.

The server stores in the database a set of configuration parameters indicating the mapping between learning target information and prompt sentence templates. For example, the server maintains a template such as:

“Please generate 5 multiple-choice questions for junior high school mathematics about linear equations. Each question must have 4 options and clearly indicate which option is correct.” and another template such as:

“Generate 10 multiple-choice questions for high school physics about Newton's laws at an intermediate difficulty level. Each question should have 4 answer choices and specify the correct choice.”

The server also stores templates for learning plan proposals, for example:

“The student answered [X] out of [Y] questions correctly on [topic]. Generate a short, encouraging feedback message and specify which areas the student should review, and propose a step-by-step learning plan for the next week.”

The server selects and parametrizes these templates according to user-provided conditions and computed performance metrics.

The terminal displays to the user a graphical user interface rendered by a browser or a native application. The terminal receives, from the server, markup language data and scripting language data defining interface elements for selecting learning target information and problem conditions. The terminal presents, on the display, selectable items such as subject, topic, difficulty level, and number of questions. The user uses a pointing device or a touch interface to select the desired learning target information and problem conditions. The terminal converts the user's selections into structured data and transmits the structured data to the server via the network interface.

The server receives the structured data representing the learning target information and the problem conditions. The server transforms this structured data into a prompt sentence by performing deterministic string processing operations, including variable substitution, conditional inclusion of phrases, and enforcement of a controlled output format. For example, when the user selects “junior high school mathematics” as the subject, “linear equations” as the topic, “beginner” as the difficulty level, and “5” as the number of questions, the server constructs a prompt sentence:

“Please generate 5 beginner-level multiple-choice questions about junior high school mathematics, specifically linear equations. Each question must have 4 options and clearly indicate which option is correct. Use plain language suitable for a first-time learner.” The server stores the generated prompt sentence in association with a session identifier and transmits the prompt sentence to the generative AI model by embedding the prompt sentence into request data that includes control parameters such as maximum output length, temperature, and output format hints.

The generative AI model, in one embodiment, is a transformer-based neural network including a stack of self-attention layers, feed-forward layers, and normalization layers. The model processes the prompt sentence as a sequence of token embeddings, applies multi-head self-attention to capture contextual relationships between tokens, and generates a probability distribution over a vocabulary for each subsequent token. The model has been previously trained on large-scale text corpora using supervised and unsupervised learning with an objective function such as cross-entropy loss. The model parameters, including weight matrices for attention and feed-forward layers, are optimized using gradient-based learning with backpropagation and an optimization algorithm such as Adam. The generative AI model is further fine-tuned on a corpus of educational questions and answer formats so that its output respects constraints such as “multiple choice,” “number of options,” and “explicit indication of correct answer.”

The generative AI model receives the prompt sentence from the server and generates text that includes a set of questions, options, and correct answer indications. The server receives the generated text as problem information. The server then executes a parsing module that converts the free-form text into a predetermined data structure. The parsing module uses a non-conventional parsing pipeline specifically designed for AI-generated content: the server first enforces a prompt format that encourages the generative AI model to output numbered questions and labeled options (for example, “Question 1: (A)(B)(C)(D) Correct answer: B”). Then the server splits the generated text according to question delimiters, extracts option labels and texts using pattern rules, and maps them to a normalized representation with fields such as question identifier, question text, list of option texts, and index of the correct option. As a result, the server can robustly parse varied AI outputs without manual intervention.

The server stores the normalized problem information in the database or in main memory and uses a templating subsystem to generate screen data for an online test. The server inserts each question and its options into markup language structures for forms and form controls, and the server inserts scripting language logic that collects user selections, prevents submission of incomplete answers, and transmits answer data asynchronously to the server. This arrangement allows the server to decouple the internal data structure from the user interface layer and to reuse the same data structure for different types of terminals with different display resolutions.

The terminal receives the screen data and renders the online test interface. The terminal executes the scripting language code to dynamically update the display according to user interactions. The user reads each question and selects one of the displayed choices. The terminal generates answer data, including the question identifiers and selected choice indices, and transmits the answer data to the server.

The server receives the answer data and retrieves the associated correct answer information from the predetermined data structure stored in memory or in the database. The server performs arithmetic operations by iterating over each question, comparing the user's selected index with the stored correct index, and incrementing a counter of correct answers when the indices match. The server calculates a correct answer rate by dividing the number of correct answers by the total number of questions and, when needed, multiplying by 100 to convert the rate into a percentage. The server then classifies the level of understanding by applying threshold logic to the correct answer rate, for example defining ranges such as at least 80 percent, between 50 and 79 percent, and below 50 percent. The server stores the classification result and the numeric metrics as learning history information associated with the user.

The server generates feedback information responsive to the classified level of understanding. In one embodiment, the server uses rule-based templates to produce deterministic feedback strings. In another embodiment, the server constructs a new prompt sentence that includes summary performance data and requests the generative AI model to produce nuanced feedback. For example, the server constructs a prompt sentence:

“The student answered 7 out of 10 questions correctly (70%) on junior high school mathematics, linear equations. Generate a short, encouraging feedback message, point out common misconceptions the student might have, and propose 3 concrete practice tasks for the student.”

The server sends this prompt sentence to the generative AI model and parses the returned feedback text in a simpler manner, because the feedback is consumed as natural language rather than as structured problem data.

The server further uses the computed level of understanding and the learning history information to generate additional prompt sentences for supplementary problem generation or learning plan proposals. For example, when the user's level of understanding is classified as low, the server may construct:

“Generate 5 remedial multiple-choice questions on linear equations for a student who scored below 50 percent. Focus on basic concepts: identifying coefficients, understanding variable terms, and recognizing equality. Each question must have 4 options and indicate the correct option.”

When the level is high, the server may generate:

“Generate 5 advanced multiple-choice questions on linear equations that include word problems and simultaneous equations. Each question must have 4 options and indicate the correct option.”

By programmatically steering the generative AI model using such performance-dependent prompt sentences, the server creates a feedback loop where numeric metrics computed by the processor directly influence the generation of new educational content.

The server also generates display control information for an interactive dashboard. The server maintains, in the database, time-series records of test sessions including timestamps, topics, numbers of questions, numbers of correct answers, correct answer rates, and classification results. The server aggregates this time-series data into structured data suitable for visualization, including arrays of timestamps and corresponding performance values. The server additionally generates drawing control data specifying chart types (for example, line charts or bar charts), axis scales, labels, and color assignments for different performance levels. The server sends the structured data and the drawing control data to the terminal, which renders an interactive dashboard using a visualization library. The terminal can update the dashboard incrementally when new display control information is received, avoiding the need to reload full page content and thereby reducing communication load and latency. This architecture improves computer technology beyond mere human task automation in several ways. First, the server uses non-conventional data structures and prompt generation policies tailored to AI-generated educational content, which reduces parsing errors and eliminates a class of manual curation operations that would otherwise be necessary. By constraining the output format at the prompt level and normalizing the responses into a unified internal representation, the server decreases the number of failed or unusable model outputs, thereby improving processing efficiency and reducing network calls required for re-generation.

Second, the server integrates numeric performance computation and time-series management with the control of the generative AI model. The server does not merely present scores to the user; instead, the server transforms the scores into structured prompt conditions that modify the behavior of the external model. This coupling of internal metrics with generative control leads to automated adaptation that could not be realistically performed by human operators in real time at scale, and that improves the resource utilization of the underlying computing infrastructure by dynamically adjusting the number of generated questions and the complexity of the content to the user's needs.

Third, the server uses the generative AI model in combination with deterministic, rule-based post-processing and data validation. The server applies consistency rules to the generated problem information, such as requiring a fixed number of options per question and a unique correct answer. If a generated output fails these checks, the server can issue a modified prompt sentence with tighter instructions. This hybrid strategy of probabilistic generation and deterministic correction decreases the probability of offering invalid problems to the user and enhances the reliability and safety of the system as a computing platform.

Fourth, the server's dashboard subsystem operates on structured performance data and drawing control data generated by the processor, thereby separating visualization logic from business semantics. The server can optimize the volume and frequency of data updates to the terminal, sending only incremental differences or compressed data points. This results in reduced communication load and faster rendering on resource-constrained terminals. The user thus experiences near real-time visualization of learning progress, and the instructor can monitor many learners concurrently without overwhelming the computing resources.

In one alternative embodiment, the server hosts the generative AI model locally instead of accessing a remote model. In this case, the processor on the server is coupled to a graphics processing unit and a model storage unit storing the neural network parameters. The server loads the model into GPU memory and executes the generation process locally. The same prompt sentence generation, parsing, and feedback logic are applicable, but the model execution is under direct control of the server, allowing the server to tune batch sizes, precision modes (for example, floating-point precision), and caching strategies to balance latency and throughput. This configuration can further improve response time and reduce dependency on external service providers.

In another alternative embodiment, the server maintains multiple generative AI models with different architectures or training datasets, such as a model specialized for mathematics and a model specialized for language learning. The server selects one of the models based on the learning target information and performance data and generates model-specific prompt sentences that exploit domain-specific capabilities. For example, for language learning, the server may generate a prompt sentence requesting distractor options that are common learner errors, thereby leveraging the model's ability to model typical error patterns. This model selection mechanism improves the technical performance of the system by matching model capabilities to task requirements.

In yet another embodiment, the server implements a caching mechanism in which the server stores associations between prompt sentences and previously generated problem sets. When a new prompt sentence is sufficiently similar to a stored one according to a similarity metric computed over token sequences, the server can reuse or partially reuse existing problem sets rather than requesting new content from the generative AI model. This reduces network traffic and model computation time, thereby decreasing latency and resource consumption. The described embodiments show that the server, the terminal, and the generative AI model cooperate through specifically designed data structures, processing sequences, and model-control mechanisms that improve the functioning of the computer system as a whole. The server does not simply implement an abstract data processing flow; instead, the server orchestrates neural network computation, structured prompt generation, robust parsing, adaptive content control, and real-time visualization in a way that enhances processing speed, correctness, scalability, and user experience. The causal relationship between the described processing and the technical effects is realized through the enforced output formats, the integration of performance metrics into model prompts, the hybrid rule-based and probabilistic validation of generated content, and the optimized management of time-series learning data and dashboard updates.

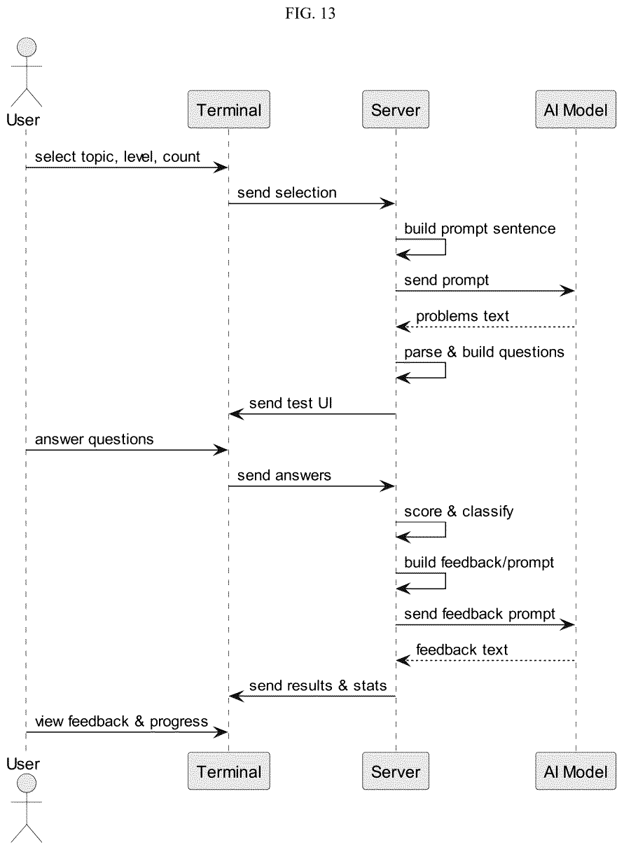

The following describes the processing flow using FIG. 13.

### Step 1:

Server sends, to the terminal, screen data for selecting learning target information and problem conditions.

Server uses a markup language and a scripting language to generate a user interface including selectable elements (subject, topic, difficulty, number of questions).

Input: configuration data stored in a storage device (e.g., lists of available subjects, topics, difficulty levels, and allowable ranges for question counts).

Server processes this configuration data by embedding each item into HTML elements and binding event handlers in a scripting language; as a result, server outputs structured screen data and transmits it to the terminal.

### Step 2:

Terminal receives the screen data and renders a selection screen on a display.

Terminal executes the scripting language code to create interactive components such as drop-down lists, radio buttons, and text fields.

Input: screen data (HTML, CSS, and scripting code) from the server.

Terminal processes this input by parsing and rendering the markup and executing associated scripts; as a result, terminal outputs a visible user interface and internal data structures representing the current selection state.

### Step 3:

User operates the terminal to select learning target information and problem conditions.

User chooses items such as subject, topic, difficulty level, and number of questions using a keyboard, mouse, or touch interface.

Input: displayed selection screen and available UI controls.

User interaction produces updated selection values; as a result, terminal outputs structured data (for example, a key-value set with fields for subject, topic, difficulty, and question_count).

### Step 4:

Terminal transmits the selected learning target information and problem conditions to the server.

Terminal converts the structured selection data into a format suitable for network transmission, such as a JSON object, and sends it using a network protocol.

Input: structured selection data generated in Step 3.

Terminal performs serialization and encapsulates the serialized data into a network request; as a result, terminal outputs a request message containing the selection data and transmits it to the server.

### Step 5:

Server receives the selection data and stores it as session information.

Server parses the received message to extract the subject, topic, difficulty level, and question count, and associates these values with a user session identifier.

Input: request message containing serialized selection data.

Server performs parsing and type conversion operations to convert strings into internal representations (e.g., enumerations or numeric values); as a result, server outputs normalized session data stored in main memory or in a database.

### Step 6:

Server generates a prompt sentence for a generative AI model based on the selection data.

Server selects a template corresponding to the subject and difficulty level and inserts the topic and question count into template placeholders.

Input: normalized session data including subject, topic, difficulty level, and question count.

Server performs character string processing (replacement of placeholders, conditional addition of phrases) on the template; as a result, server outputs a prompt sentence such as “Please generate 5 beginner-level multiple-choice questions about junior high school mathematics, specifically linear equations. Each question must have 4 options and clearly indicate which option is correct.”

### Step 7:

Server transmits request data including the prompt sentence to the generative AI model.

Server forms a request payload that contains the prompt sentence and control parameters such as maximum token length, temperature, and expected format description.

Input: prompt sentence generated in Step 6 and configuration parameters for the generative AI model.

Server performs data structuring to construct a request object for an API call and sends it via a communication interface; as a result, server outputs a network request to the generative AI model.

### Step 8:

Server receives problem information generated by the generative AI model.

Server obtains a response message that contains textual content describing questions, choices, and correct answer indications.

Input: response data from the generative AI model, which is generated internally by a transformer-based neural network processing the prompt sentence.

Server performs response parsing to extract the text portion from the response format; as a result, server outputs a raw problem text string or an unstructured text block containing multiple questions.

### Step 9:

Server analyzes the problem information and converts it into a predetermined data structure.

Server splits the raw text into individual question segments, extracts each choice and its label, and determines the correct choice identifier from phrases such as “Correct answer: B.”

Input: raw problem text string output in Step 8.

Server applies parsing rules, regular expression matching, and tokenization to map question texts, option texts, and correct answer labels into structured records; as a result, server outputs a list or array of question objects, each including fields for question text, list of choices, and correct answer index.

### Step 10:

Server validates and, if necessary, adjusts the structured problem data.

Server checks that each question has the specified number of choices and exactly one correct answer, and verifies that no field is empty.

Input: list or array of question objects from Step 9.

Server performs logical consistency checks and counting operations on each object; if a question fails validation, server may mark it for regeneration or correction; as a result, server outputs a validated set of problem data that satisfies predetermined constraints.

### Step 11:

Server generates online test screen data based on the validated problem data.

Server creates markup language elements representing question texts and choice controls, and generates scripting logic to capture user selections and manage form submission.

Input: validated problem data from Step 10.

Server performs template instantiation, inserting question texts and choices into predefined HTML structures, and generates event-handling scripts bound to each choice; as a result, server outputs online test screen data ready to be sent to the terminal.

### Step 12:

Server transmits the online test screen data to the terminal.

Server sends an HTTP response or an equivalent message containing the markup and scripting code required to present the questions.

Input: online test screen data from Step 11.

Server wraps this data in a response message and uses the network interface to deliver it; as a result, server outputs a network response which the terminal receives.

### Step 13:

Terminal receives and renders the online test screen.

Terminal interprets the markup language and style definitions to display numbered questions and clickable choices, and executes the scripting language code to attach event handlers.

Input: network response with online test screen data from Step 12.

Terminal processes the response by parsing HTML, applying style rules, and initializing JavaScript objects; as a result, terminal outputs a fully interactive online test interface on the display and internal state variables to track user selections.

### Step 14:

User reads the displayed questions and selects answers on the terminal.

User interacts with choice controls such as radio buttons or buttons to designate an answer for each question.

Input: visual representation of questions and choices on the display.

User operations cause the terminal to update selection variables in the scripting environment; as a result, terminal outputs updated local answer state data reflecting the user's current choices.

### Step 15:

Terminal collects the final answer data and transmits it to the server.

Terminal triggers submission logic when the user activates a “Submit” control, validates that all required questions have been answered, and assembles a data structure containing question identifiers and selected choice indices.

Input: internal answer state data accumulated in Step 14 and metadata about question identifiers.

Terminal performs data aggregation and serialization to convert the answer state into a compact representation (e.g., JSON) and sends it as a request message; as a result, terminal outputs answer data to the server.

### Step 16:

Server receives the answer data and retrieves corresponding correct answer information.

Server parses the incoming message to obtain each question identifier and selected choice index, and fetches the correct answer index from the predetermined data structure stored in memory or the database.

Input: answer data from Step 15 and the stored question objects from Step 10.

Server performs key-based lookups using question identifiers to associate each user selection with its correct answer; as a result, server outputs a combined dataset that pairs user selections and correct answers for each question.

### Step 17:

Server computes a number of correct answers and a correct answer rate.

Server compares each selected choice index with the corresponding correct answer index and counts how many matches occur.

Input: combined dataset of user selections and correct answer indices from Step 16.

Server performs comparison operations in a loop, increments a counter for correct answers, and applies arithmetic operations (division, and optionally multiplication by 100) to calculate the correct answer rate; as a result, server outputs numeric values representing the number of correct answers and the correct answer rate.

### Step 18:

Server classifies a level of understanding based on the correct answer rate.

Server applies pre-defined thresholds to the correct answer rate to map it into categories such as high, medium, or low.

Input: correct answer rate computed in Step 17.

Server performs conditional branching (e.g., if-else comparisons) to determine the appropriate category; as a result, server outputs a level of understanding label and links this label to the current test session.

### Step 19:

Server generates feedback information according to the level of understanding.

Server either selects a pre-defined feedback template or constructs a new prompt sentence to request feedback text from the generative AI model.

Input: level of understanding label from Step 18 and, optionally, additional statistics such as number of correct answers and topic information.

Server performs either template substitution (for rule-based feedback) or character string processing to create a feedback-oriented prompt sentence, then optionally sends this prompt sentence to the generative AI model and receives a feedback text; as a result, server outputs feedback information comprising textual guidance, recommendations, and explanations.

### Step 20:

Server updates learning history information and generates new prompt sentences for supplementary problems or learning plans.

Server stores the latest correct answer rate, level of understanding, and topic information with a timestamp in a learning history record, and uses these values to select or parameterize a new template suited for remedial or advanced content.

Input: performance metrics and level of understanding from Steps 17 and 18, and existing learning history data from the database.

Server performs data insertion and aggregation operations on the learning history, and applies rule-based logic to determine the next type of content (e.g., remedial or advanced); as a result, server outputs new prompt sentences for supplementary problem generation or learning plan proposals tailored to the user's current status.

### Step 21:

Server generates display control information for visualization of learning progress and test results.

Server aggregates time-series data of previous test sessions, including timestamps, correct answer rates, and levels of understanding, into structured arrays and constructs drawing control parameters specifying chart type, axis ranges, and color schemes.

Input: updated learning history records including the latest session from Step 20.

Server performs grouping, sorting, and numerical normalization on time-stamped performance values, and combines the processed arrays with visualization parameters; as a result, server outputs display control information ready to be transmitted to the terminal for rendering an interactive dashboard.

### Step 22:

Server transmits the level of understanding, feedback information, supplementary problems or learning plan proposal, and display control information to the terminal.

Server packages these elements into response messages that include both textual content and structured data series.

Input: level of understanding from Step 18, feedback information from Step 19, new prompt-derived content from Step 20, and display control information from Step 21.

Server performs message composition and encoding, then sends the messages via the network interface; as a result, server outputs response data for presentation and visualization on the terminal.

### Step 23:

Terminal receives the response data and updates the display with feedback and visualizations.

Terminal parses the response messages, displays the level of understanding and feedback text, and uses the structured performance data and drawing control parameters to render or update charts on an interactive dashboard.

Input: response data transmitted from the server in Step 22.

Terminal executes visualization logic in the scripting language to create or modify graphical elements (e.g., lines, bars, labels) according to the drawing control parameters; as a result, terminal outputs an updated user interface in which the user can see current evaluation results and a graphical history of learning progress.

### Step 24:

User reviews the feedback, supplementary content, and learning progress visualization on the terminal.

User may decide to start a new supplementary test or follow a proposed learning plan using interface controls presented on the dashboard.

Input: displayed feedback information, new problem links or buttons, and visualization of time-series performance data.

User actions based on this information generate new selection operations similar to those in Step 3; as a result, the user's new choices form updated input data for another iteration of the processing flow.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented learning support systems primarily treat the computer as a passive conduit for static content delivery and score calculation. In such systems, a processor typically retrieves fixed questions from a database, records answers, and computes simple scores. These systems do not leverage the full capability of modern information processing techniques to improve how the computer structures, interprets, and uses learner data. In particular, conventional systems exhibit several technical limitations. First, the processor usually maintains only coarse progress indicators (for example, total correct answers or completion flags) without constructing a machine-readable, fine-grained profile of understanding by topic and by difficulty. As a result, the system cannot dynamically reorganize its internal data selection and processing logic in a way that optimally matches the learner's current state. The computer remains a static rule engine, and the internal data flow for question selection, evaluation, and feedback generation cannot be adaptively optimized.

Second, existing systems that use generative models typically invoke such models in an ad hoc manner: the model is asked to “generate some questions” or “suggest some materials” without a structured machine-oriented context. Prompt text is written as one-off instructions, and there is no systematic process within the processor for generating and updating prompt sentences based on structured profiles, progress indicators, and emotional state.

Consequently, the interaction between the processor and the generative model is not integrated into the core control loop of the system, and the generative model is not effectively constrained or steered by the system's internal state. This leads to unstable quality of generated outputs and inefficient use of computational resources.

Third, conventional systems do not treat progress monitoring, notification generation, and visualization as part of a closed-loop control mechanism implemented at the processor level. Progress dashboards are often static web pages or external analytics tools that periodically poll databases, rather than being driven by a processor that actively aggregates logs, computes indices, and triggers real-time visual updates and notifications. Therefore, the system cannot quickly adapt content selection and planning logic based on the latest learning activity, and cannot provide instructors with real-time, machine-interpretable signals for intervention.

Fourth, when generative models are used to create new questions or training tasks, conventional systems typically handle the outputs as free-form text that is directly shown to users. There is no standardized internal pipeline in which the processor converts generative outputs into structured data, validates them, and merges them with existing task sets using algorithmic filters. As a consequence, the computer cannot robustly maintain a task collection that satisfies target distributions of difficulty and topic coverage, and the system may fail to guarantee that the learner receives an appropriate mix of tasks.

Fifth, many systems ignore affective signals or treat them in isolation from the core content-selection logic. Even when emotional state is detected, it is not integrated into a unified model of understanding and progress that can systematically influence how the processor configures prompts, plans, and resource selection. This prevents the computer from operating as a holistic adaptive controller that jointly optimizes for cognitive and affective states.

Accordingly, there is a need for an improved computer-implemented learning support system in which a processor (i) builds and maintains structured understanding profiles and progress indices, (ii) generates and updates machine-targeted prompt sentences for a generative AI model based on these profiles and indices, (iii) uses the outputs of the generative AI model as internal signals for dynamically reconfiguring learning plans, task sets, and resource mappings, (iv) algorithmically validates and merges generated tasks into managed task sets, and (v) continuously drives interactive dashboards and notification channels in a closed feedback loop. Such a system would technically improve the way a computer organizes and processes learning data, coordinates with a generative AI model, and presents adaptive information to users and instructors, resulting in more efficient and reliable operation of the entire learning support infrastructure.

The specific processing by the specific processing unit 290 of the data processing device 12 in Application Example 2 is realized by the following means.

The present invention provides a server comprising a processor configured to acquire learning target information selected by a user, search task information stored in a storage apparatus based on the learning target information, select task information having multiple difficulty levels, receive answer information from a user terminal, compute understanding degree indices by field and by difficulty according to evaluation criteria, record the indices as an understanding profile, generate prompt sentences that encode the understanding profile, user attribute information, progress indices, and emotional state information as structured context for a generative information processing model, input the prompt sentences to the generative information processing model to obtain learning plan candidates and explanation information, integrate the learning plan candidates and the explanation information with the understanding profile to form learning plan information, search educational resource information based on the learning plan information, select and associate learning materials and learning methods with the learning plan information, aggregate learning activity logs into time-series progress indices, generate notification information including support requests and instructor intervention requests according to the understanding profile and the progress indices, search and filter related task information to configure a task set adapted to a learning level of the user, cause the generative information processing model, via further prompt sentences, to generate new task candidates when a predetermined number or distribution of tasks is insufficient, convert and validate the new task candidates as structured data before adding them to the task set, and generate updatable visual representation data that presents the understanding profile, the progress indices, task execution history, and notification history as interactive dashboard elements. This enables the server to operate as an adaptive control core that continuously restructures internal data flows and model interactions based on machine-interpretable profiles and indices, thereby improving the computer's ability to (i) algorithmically select and maintain appropriate task sets, (ii) systematically steer a generative AI model through context-rich prompt sentences, and (iii) provide real-time, closed-loop visualization and notification capabilities that enhance the technical performance and responsiveness of the learning support system.

The term “learning target information” refers to information indicating a subject, topic, skill, or content area that a user has selected as a target for learning or training, and that is used by the system to drive search and selection of task information and resources.

The term “information processing apparatus” refers to an electronic device, such as a server, personal computer, or mobile terminal, that executes instructions to process data including learning target information, task information, answer information, and learning activity logs.

The term “storage apparatus” refers to a data storage component, such as a memory device or database system, that stores task information, educational resource information, user profiles, understanding profiles, and learning activity logs in a machine-readable form.

The term “task information” refers to structured data describing an assessment item, practice item, or training item, including at least a problem statement or instruction, one or more expected responses or correct answers, and associated metadata such as topic, difficulty, and tags.

The term “difficulty attribute” refers to metadata associated with task information that indicates a relative level of complexity or challenge, and that enables the system to classify and select tasks across multiple difficulty levels.

The term “user terminal” refers to an end-user device, such as a smartphone, tablet, or personal computer, that provides a user interface for selecting learning targets, presenting tasks and learning plans, capturing answers, and transmitting data to and from the server.

The term “answer information” refers to data representing a user's response to task information, including selected options, entered text, timestamps, and any associated interaction metrics that are submitted from the user terminal to the server.

The term “evaluation criterion” refers to a rule set or algorithm used by the processor to determine correctness or quality of answer information relative to corresponding task information.

The term “understanding degree index” refers to a numerical indicator computed by the processor that represents a level of user understanding for a given topic, field, or difficulty, derived from evaluation results of one or more tasks.

The term “understanding profile” refers to a structured collection of understanding degree indices organized by topic, field, and/or difficulty, which is stored and updated by the processor to represent the user's current understanding state.

The term “user attribute information” refers to data characterizing a user, such as age, grade, prior history, preferences, or role, which is used by the processor as context when generating learning plans and prompt sentences.

The term “generative information processing model” refers to a machine learning model, such as a generative artificial intelligence model, that generates text or other data outputs based on input data including prompt sentences, and that is used to produce learning plan candidates, explanations, and task candidates.

The term “prompt sentence” refers to a machine-interpretable instruction text generated by the processor and provided to the generative information processing model, the instruction text describing a task for the model such as generating learning plan candidates, explanations, or new task candidates based on supplied context.

The term “learning plan candidate” refers to data produced by the generative information processing model that represents a proposed sequence or structure of learning activities, including recommended topics, tasks, and scheduling information, before integration and validation by the processor.

The term “explanation information” refers to descriptive output generated by the generative information processing model or by the processor, which interprets understanding profiles, scores, or other state data in natural language or structured form.

The term “learning plan information” refers to processed and integrated plan data produced by the processor by combining a learning plan candidate, explanation information, and understanding profile, and that specifies concrete future learning activities for the user.

The term “educational resource storage apparatus” refers to a storage component or database that stores educational resource information such as learning materials, training resources, and associated metadata used to support learning plans.

The term “teaching resource information” refers to data describing an educational resource, such as a document, problem set, or instructional content, that can be used to teach or reinforce a concept.

The term “training resource information” refers to data describing a resource specifically intended to support skill training or practice, such as drills, simulations, or task sequences.

The term “learning material information” refers to data identifying and describing educational materials, such as texts, videos, exercises, or interactive modules, selected by the processor for presentation as part of a learning plan.

The term “learning method information” refers to data describing recommended strategies or approaches for learning, such as study techniques, practice patterns, or interaction styles, which the processor associates with the learning plan.

The term “learning activity log information” refers to records of user activities related to learning, such as task attempts, resource accesses, durations, and navigation events, which are collected by the user terminal and transmitted to the server.

The term “learning terminal” refers to a particular instance of a user terminal, used by a learner to perform learning activities, display content, interact with tasks, and send log information to the server.

The term “progress index” refers to a numerical or categorical indicator computed by the processor that represents a state of advancement of the user through tasks, resources, or plan steps over time.

The term “progress state” refers to a representation of the user's overall learning progression at a given time, derived from one or more progress indices and activity logs.

The term “notification information” refers to message data generated by the processor to inform a user, instructor, or external system about a condition, such as the need for support, an intervention request, or a status update.

The term “support request” refers to a type of notification information that indicates the system has determined that the user may need additional assistance, such as hints, remediation, or alternative content.

The term “instructor intervention request” refers to a type of notification information that prompts a human instructor or supervisor to actively intervene in the user's learning process based on monitored understanding and progress.

The term “filtering algorithm” refers to a computational procedure applied by the processor to a collection of task information to select a subset that meets specified conditions, such as topic relevance, difficulty range, or redundancy constraints.

The term “task set” refers to a collection of task information items selected and managed by the processor for use within a particular learning session or plan, and having controlled properties such as difficulty distribution and topical coverage.

The term “topic information” refers to data specifying a conceptual category, subject, or subtopic associated with tasks or learning materials, used by the processor in selection and generation operations.

The term “target difficulty information” refers to data specifying a desired difficulty level or distribution for tasks or activities, which is used by the processor and generative model to control task generation and selection.

The term “educational purpose information” refers to data describing a pedagogical goal, such as “reinforcement,” “diagnostic assessment,” or “advanced challenge,” used as context in prompt sentences and plan generation.

The term “new task candidate” refers to task information output by the generative information processing model in response to a prompt sentence, prior to validation and integration into a task set by the processor.

The term “structured data” refers to data organized according to a defined schema or data model, such as fields for problem text, options, correct answers, topic, and difficulty, enabling programmatic processing by the processor.

The term “verification and formatting processing” refers to operations performed by the processor to check newly generated task candidates for consistency, completeness, and compliance with constraints, and to convert them into the internal structured data format.

The term “visual representation data” refers to data describing graphical or visual elements, such as charts, indicators, and layouts, that represent understanding profiles, progress indices, histories, and other states for display on a user interface.

The term “updatable display information” refers to visual representation data that is configured to be dynamically refreshed or redrawn in response to changes in underlying learning state information.

The term “interactive dashboard element” refers to a display component, such as a chart, table, or control widget, that both presents learning state information and allows user interaction, such as selection, filtering, or navigation.

The term “learning state information” refers to aggregated data that characterizes the current condition of learning for a user, including understanding degree indices, progress indices, task execution history, and notification history.

The term “task execution history” refers to logged data representing which tasks were presented, how the user responded, and what the outcomes were over time.

The term “notification history” refers to logged data representing notifications previously generated and delivered by the system, including their types, timestamps, recipients, and statuses.

The term “emotional state information” refers to data representing an inferred or measured emotional condition of the user, such as stress, frustration, or engagement, which can be used as context in prompt sentences and adaptation logic.

In one embodiment, a server implements the claimed system as a network-connected computing apparatus including at least one central processing unit, a volatile memory, a non-volatile storage device, a network interface, and a display or dashboard interface module. The server executes an operating system such as a general-purpose server operating system, and a server-side application stack implemented, for example, in a high-level programming language with a web framework and a database management system. The server cooperates with one or more terminals operated by a user. Each terminal includes a processor, a memory, a display, input devices such as a touchscreen or keyboard, optionally a camera and a microphone, and executes a client application implemented, for example, with a native mobile application framework or a web browser.

The server stores, in a relational database management system such as a general SQL database, multiple tables including at least: a task table, a user table, an understanding profile table, an activity log table, a resource table, and a notification table. The server uses a data access layer (for example, an object-relational mapping library) to retrieve and update records in these tables. The task table stores task information in a structured schema including fields such as a task identifier, topic identifier, difficulty attribute, problem text, answer type, correct answer representation, and metadata tags. The understanding profile table stores, per user and per topic, understanding degree indices for multiple difficulty levels, together with timestamps and aggregation parameters.

The server maintains a generative AI model as a generative information processing model. In one embodiment, the server deploys a neural network implemented by a deep learning framework such as a tensor-based numerical computation library. The generative AI model has an encoder-decoder architecture with an attention mechanism or a transformer-type architecture. The model receives tokenized text sequences as input and outputs tokenized text sequences representing generated content. The server stores model parameters, including embedding matrices, multi-head attention weights, feed-forward layer weights, and normalization parameters, in a model storage area on a persistent storage device. The model is trained prior to deployment using a corpus of educational texts and task patterns, with supervised fine-tuning on instruction-style prompt-response pairs.

The server configures the generative AI model with a loss function such as a cross-entropy loss between predicted tokens and reference tokens, and updates model weights during training using an optimization algorithm such as Adam or stochastic gradient descent with momentum. During fine-tuning, the server presents training examples in which the input includes structured context encoded as text (for example, topic, difficulty, score distributions), and the output includes learning plan candidates or task candidates in a constrained textual format. The server applies regularization techniques such as dropout and weight decay to improve generalization. Data augmentation can be applied by paraphrasing prompts, shuffling context order, or injecting synthetic score distributions to increase robustness to varied input conditions.

The server stores prompt templates as text patterns containing placeholders for context variables. When the server generates a prompt sentence, the server fills placeholders with values from the understanding profile, progress indices, user attributes, and optional emotional state information. For example, the server can generate a prompt sentence of the form:

“Generate a 7-day learning plan for a learner who is weak in definite integrals (scores: easy 40%, medium 20%) and strong in limits (scores: easy 90%, medium 85%). Include daily objectives, recommended difficulty levels, and number of practice problems per day.”

Another example of a prompt sentence generated by the server is:

“Based on the following topic-wise scores (Derivatives: 80, Integrals: 40, Limits: 90), evaluate the learner's understanding, summarize weak areas, and propose three concrete learning actions.”

Yet another example of a prompt sentence is:

“Generate five beginner-level multiple-choice questions about medieval European history to test basic factual knowledge, each with four answer options and a correct answer.”

The server converts each prompt sentence into a sequence of tokens according to a tokenizer consistent with the generative AI model, arranges the tokens into a tensor, and invokes the model's inference function on a dedicated compute thread. The server controls decoding with parameters such as maximum sequence length, temperature, top-k or top-p sampling, and prohibits undesired token patterns by masking specific token IDs. The model outputs a sequence of tokens that the server converts back to text. The server then parses the text to extract structured fields for a learning plan candidate or task candidates, using rule-based parsers or pattern matching based on delimiters and labels included in the model's output format.

The server uses numerical computation libraries to compute understanding degree indices. For each user and for each topic and difficulty, the server represents aggregated performance as fixed-size vectors that include statistics such as number of attempts, number of correct answers, mean accuracy, exponentially weighted moving average of recent accuracy, and distribution of response times. The server maps these statistics into a scalar understanding degree index using a weighting function. For example, the server can compute a weighted sum of accuracy and recent performance, adjusted for difficulty, and apply a non-linear transformation such as a logistic function to normalize the index to a range from 0 to 100. The server stores the resulting indices in the understanding profile table and updates them incrementally when new answer information arrives. This incremental update uses differential aggregation formulas that avoid full recomputation, thereby improving processing efficiency, especially when the system manages many users and tasks.

The server generates progress indices by aggregating learning activity log information from terminals. Each activity log entry includes a user identifier, a timestamp, an activity type (for example, “task_attempt”, “resource_view”), a resource or task identifier, a duration, and a result code. The server groups activity logs into fixed time windows (for example, per hour or per day) and computes progress indices such as total active learning time per topic, number of completed plan steps, and rate of change of understanding degree indices. The server stores progress indices in dedicated progress tables and exposes them to visualization and notification modules. Compared to a naive logging system, this structured aggregation reduces the volume of data that must be scanned for each visualization update, which enhances responsiveness and reduces computational load.

The server generates visual representation data by transforming understanding profiles and progress indices into graphical configuration structures. For example, the server encodes a bar chart as a structured object including axis configurations, series data for each topic, and formatting parameters. When the server detects that the understanding profile or progress indices have changed, the server updates only the affected series or data points, and transmits a compact diff or incremental update to terminals. This reduces network traffic and speeds up refresh of the interactive dashboard compared to full redraw of static pages.

The terminal implements a user interface using a user interface framework. The terminal renders interactive charts, tables, and controls representing the visual representation data supplied by the server. The terminal allows a user to filter by topic, expand details for specific days, and request new tasks or plan updates. When the user interacts with the dashboard, the terminal sends interaction events back to the server, which can further refine the learning plan or task selection. The terminal also captures task answers and transmits answer information to the server. In some embodiments, the terminal uses local caching of task sets and resource metadata to reduce network latency and provide resilience against temporary disconnections.

The server uses the generative AI model in a non-conventional way by tightly coupling prompt generation to machine-maintained state. The server constructs prompt sentences from internal data structures understanding profiles, progress indices, and emotional state information using deterministic templates and encoding rules, rather than manually authored free-form queries. This allows the server to systematically control the generative AI model as a computational component in a closed control loop. Because the server converts outputs back into structured data via parsing rules, the system is able to automatically assess and, if necessary, reject or correct generated outputs that do not satisfy schema constraints, rather than simply presenting raw text to the user. This structured interaction reduces errors such as malformed questions or inconsistent plans and improves the reliability of the overall computer system.

The server improves computational efficiency by maintaining a task set that satisfies predefined distributions over topics and difficulty levels. The server represents the task set as indexed collections keyed by topic and difficulty, with associated counters. When the server determines that coverage is insufficient in a region of this distribution, the server selectively invokes the generative AI model with targeted prompt sentences that request tasks in that region only. This avoids unnecessary generation of tasks for already well-covered regions, reducing compute time spent in the generative AI model and memory used to store redundant tasks. Furthermore, by converting generative outputs into reusable structured tasks and storing them in the task table for future sessions, the system amortizes the cost of generation over multiple users and sessions.

In some embodiments, the server incorporates emotional state information derived from data captured by terminals. The terminal acquires image frames from a camera and, optionally, audio segments from a microphone, subject to user consent. The terminal transmits these data or extracted features to the server. The server applies a computer vision pipeline that uses a convolutional neural network, trained on labeled facial expression data, to output probability distributions over emotional labels such as “calm,” “focused,” “stressed,” or “frustrated.” The server optionally converts audio to text using speech recognition and applies a text sentiment classifier to detect textual cues of emotional state. The server fuses outputs of these models with a rule-based or neural fusion mechanism, generating emotional state information that it stores alongside understanding profiles.

The server uses the emotional state information to adapt prompt sentences and learning plan generation. For instance, when the server detects that the user is repeatedly “stressed” while interacting with integral tasks, the server produces prompt sentences that explicitly mention this condition, such as:

“The learner shows signs of stress while solving integral problems and currently scores 30% on basic integral tasks. Propose a gentle review plan with simpler examples and more explanations for the next three sessions.”

Because this emotional context is embedded into the prompt sentences and processed by the generative AI model, the outputs incorporate pacing and difficulty adjustments that would be challenging to maintain via static rules alone. The server then validates the generated plan by checking that recommended tasks fall within allowable difficulty bounds and that the sequence adheres to system-defined constraints.

The technical effect of these mechanisms is that the computer system improves how it internalizes and operates on learning data. By embedding structured profiles and indices into prompt sentences, the server transforms what would otherwise be opaque, high-level instructions into context-rich control signals that are machine-generated and machine-interpretable. This allows the generative AI model to operate more deterministically under system control, reduces variability of output quality, and lowers the frequency of manual corrections. The incremental aggregation of understanding indices and progress indices reduces the volume of computation required per update, enabling the server to serve many concurrent users with lower latency. The structured validation and integration of generated tasks ensure that the database remains consistent and that tasks meet quality constraints, thereby reducing runtime errors and inconsistent user experiences.

The server's architecture also improves data management. The separation of understanding profiles, progress indices, and task sets into distinct but linked tables allows the server to perform targeted queries and updates, rather than full-table scans. When generating a dashboard view, the server joins only the necessary indices and histories for a given time window and topic filter, which significantly reduces query complexity and improves response time. The use of compact incremental visualization updates further reduces network bandwidth consumption, which is advantageous when terminals operate over constrained networks.

In one alternative embodiment, the server uses a different type of generative AI model, such as a sequence-to-sequence recurrent neural network or a hybrid rule-based and neural model, while maintaining the same pattern of context-rich prompt sentences and structured output parsing. The same framework of understanding profiles, progress indices, and task sets applies, but the internal model architecture differs. In another embodiment, the system operates primarily in an on-premise environment within an institution, where the generative AI model runs on dedicated hardware accelerators, and data remains within a local network. In yet another embodiment, emotion detection is omitted, and emotional state information fields in prompt sentences are left empty or replaced with neutral values, while the rest of the adaptive mechanisms remain in place.

In a further embodiment, the server integrates motion-based skill assessment. A terminal in an industrial training setting captures motion sensor data or video describing a user's physical operations. The server extracts features such as trajectory smoothness, timing, and positional accuracy from these data using signal processing and machine learning techniques, and computes skill-related indices analogous to understanding degree indices. The server then constructs prompt sentences that include these indices and requests the generative AI model to design training sequences to improve specific skill metrics. For example:

“Based on the following motion skill indices (position accuracy: 60, movement smoothness: 45, task time: 80), propose a three-stage training plan to improve precision while maintaining current speed.”

The server parses the generated plan, validates it, and encodes it as structured training tasks with explicit parameter targets, closing the loop between sensor measurements, model inference, and training control. This embodiment demonstrates that the same underlying architecture of structured profiles, prompt sentences, generative planning, and task set management can apply to non-academic domains where physical device control or sensor feedback is present.

The described system thus does more than automate human scheduling or content selection; it introduces a new way of coordinating a generative AI model with structured, machine-maintained profiles and indices, under the explicit control of the server's algorithms. The server's configuration of data structures, aggregation methods, prompt generation logic, model invocation, output parsing and validation, and dashboard update mechanisms collectively improves the technical operation of the computing environment in terms of speed, stability, resource usage, and accuracy of adaptation.

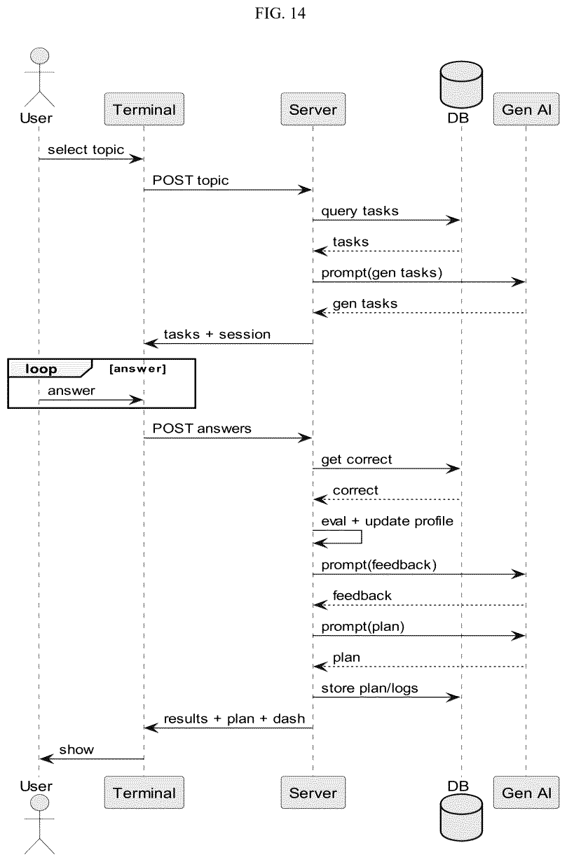

The following describes the processing flow using FIG. 14.

### Step 1:

The user selects learning target information on the terminal.

The user operates the terminal UI (for example, taps a dropdown or checkbox) to choose a subject, topic, and optionally a target difficulty and goal period.

Input: the user's manual operations on UI elements.

Output: a structured selection object on the terminal, including at least a user identifier, a subject identifier, a topic identifier, and optional parameters such as preferred difficulty, time budget, and goal type.

The terminal converts the UI state into this selection object and stores it in volatile memory.

### Step 2:

The terminal transmits the learning target information to the server.

The terminal serializes the selection object to a JSON payload and sends it via an HTTP or HTTPS POST request to a predefined API endpoint of the server.

Input: the selection object created in Step 1.

Output: an HTTP request message containing the JSON payload, delivered to the network interface of the server.

The terminal also starts a timer and displays a loading indicator to the user until a response is received.

### Step 3:

The server receives and validates the learning target information.

The server parses the incoming HTTP request, decodes the JSON payload, and verifies that the user identifier and topic identifier exist in internal tables.

Input: the HTTP request message containing the JSON payload.

Output: a validated context object containing the learning target information and a reference to the user record, or an error response if validation fails.

The server writes a log entry into an access log table, including the timestamp, user ID, topic ID, and request metadata.

### Step 4:

The server retrieves candidate task information based on the learning target.

The server issues a query to a task table of a relational database to fetch tasks matching the specified topic and spanning multiple difficulty attributes.

Input: the validated context object with subject, topic, and optional target difficulty.

Output: a list of task records, each including a task ID, topic ID, difficulty attribute, problem text, answer representation, and tags.

The server uses a database driver or ORM to execute a parameterized SQL SELECT statement and loads the resulting rows into in-memory data structures.

### Step 5:

The server filters and structures the candidate tasks into a preliminary task set.

The server applies a filtering algorithm that excludes deprecated tasks, duplicates already solved recently by the user, and tasks outside an allowed difficulty range.

Input: the list of task records from Step 4 and the user's recent task execution history from a history table.

Output: a preliminary task set organized by difficulty buckets (for example, easy, medium, hard) and topic subtags.

The server counts tasks in each bucket and stores counts and references in a task set object.

### Step 6:

The server determines coverage gaps and decides whether to invoke the generative AI model.

The server compares current counts in the task set object with target distributions (for example, at least N easy, M medium, K hard tasks).

Input: the preliminary task set with bucket counts and predefined distribution thresholds.

Output: a coverage gap description indicating how many tasks are missing per bucket, or a flag indicating that no gaps exist.

If one or more gaps exist, the server marks these buckets as needing generated tasks.

### Step 7:

The server constructs one or more prompt sentences for task generation.

The server selects a prompt template and fills placeholders using the topic ID, target difficulty, educational purpose (for example, “diagnostic assessment”), and, if available, understanding degree indices from the user's understanding profile.

Input: the coverage gap description, the learning target information, and the understanding profile of the user.

Output: one or more prompt sentences in natural language, each specifying topic, difficulty, format, and quantity of tasks required.

For example, the server may generate a prompt sentence:

“Generate five beginner-level multiple-choice questions about medieval European history to test basic factual knowledge, each with four answer options and a correct answer.”

### Step 8:

The server invokes the generative AI model to generate new task candidates.

The server tokenizes each prompt sentence, encodes it as numerical tensors, and calls the inference function of a deployed generative AI model instance.

Input: the prompt sentences from Step 7.

Output: raw text outputs from the generative AI model containing candidate tasks, including problem statements, options, and correct answers.

The server controls generation with decoding parameters (for example, maximum length, sampling temperature) to maintain desired complexity.

### Step 9:

The server parses and validates the generated task candidates.

The server applies rule-based parsers and pattern matching to extract structured fields (problem text, answer options, correct answer index, difficulty annotation) from the raw text.

Input: the raw text outputs from Step 8.

Output: a list of structured task candidate objects conforming to the internal task schema, along with validation flags indicating whether each candidate passes formatting and completeness checks.

The server rejects candidates with missing fields, duplicated options, or invalid difficulty annotations, and optionally logs such rejections for model tuning.

### Step 10:

The server merges validated generated tasks into the task set.

The server inserts validated task candidates into the task table and adds their references to the corresponding difficulty buckets in the in-memory task set object.

Input: the preliminary task set from Step 5 and the validated task candidates from Step 9.

Output: a completed task set object that meets or exceeds target distributions across difficulty and topic.

The server updates bucket counts and marks the task set as ready for delivery.

### Step 11:

The server transmits the task set to the terminal.

The server creates a response object containing the task set (task IDs, problem texts, answer options, difficulty labels) and a newly assigned session identifier, excluding correct answer details.

Input: the completed task set object from Step 10.

Output: an HTTP response message with a JSON payload describing the task set and session ID.

The server records the session metadata in a session table, including mapping from session ID to task IDs and user ID.

### Step 12:

The terminal receives and stores the task set.

The terminal parses the JSON response, constructs local task objects, and caches them in memory or local storage for the current session.

Input: the HTTP response message with the JSON task set and session ID.

Output: in-memory structures mapping task IDs to question texts, options, and difficulty attributes on the terminal.

The terminal associates the session ID with this collection and prepares the UI for question presentation.

### Step 13:

The user answers tasks presented on the terminal.

The user reads each problem on the display and selects or inputs an answer using touch or keyboard input.

Input: the task texts and options shown on the terminal.

Output: user choices or text entries stored as local answer records, each linked to a task ID and timestamp.

The terminal records the selected option, the time taken per task, and any navigation behavior (for example, revisiting questions).

### Step 14:

The terminal compiles answer information and sends it to the server.

The terminal constructs a submission payload containing the session ID, user ID, and for each task ID, the selected answer and associated timestamps.

Input: the local answer records from Step 13 and the session information.

Output: an HTTP POST request with a JSON payload representing answer information transmitted to the server.

The terminal sets a submission flag to prevent duplicate sends and displays a submission progress indicator.

### Step 15:

The server receives answer information and retrieves correct answers.

The server parses the answer payload and validates that each task ID belongs to the specified session. The server then queries the task table to obtain the correct answer representation for each task ID.

Input: the HTTP request with JSON answer information and the session table entries for the session ID.

Output: a combined data structure associating each task ID with the user's answer and the correct answer.

The server stores raw answer logs into the activity log table for traceability.

### Step 16:

The server evaluates correctness and computes understanding degree indices.

The server compares the user's answer to the correct answer for each task and flags each as correct or incorrect. The server aggregates results by topic and difficulty, computing metrics such as total attempts, correct counts, accuracy ratios, and time-per-correct.

Input: the combined data structure from Step 15 and any existing statistics in the understanding profile table for this user.

Output: updated statistics per topic and difficulty, and recalculated understanding degree indices, for example normalized scores between 0 and 100.

The server applies incremental aggregation formulas (for example, weighted moving averages) to update indices without reprocessing historical data.

### Step 17:

The server updates the understanding profile and progress indices.

The server writes the new understanding degree indices into the understanding profile table, and updates progress indices such as completed tasks, plan step completion, and learning time for the current period.

Input: the updated statistics and indices from Step 16 and activity log entries generated during evaluation.

Output: a refreshed understanding profile record and progress index records associated with the user ID and topic.

The server tags each update with a timestamp to support temporal trend analysis.

### Step 18:

The server generates a prompt sentence for qualitative evaluation and feedback.

The server selects an evaluation prompt template and fills in numeric values from the updated understanding profile, including per-topic and per-difficulty scores.

Input: the refreshed understanding profile from Step 17.

Output: a prompt sentence describing the learner's scores and requesting an interpretation and feedback.

For example, the server may generate the prompt sentence:

“Based on these topic-wise scores (Derivatives: 80, Integrals: 40, Limits: 90), evaluate the learner's understanding, explain weak areas, and propose three immediate learning actions.”

### Step 19:

The server invokes the generative AI model for qualitative evaluation.

The server tokenizes the prompt sentence, runs inference on the generative AI model, and obtains a textual explanation and recommendations.

Input: the evaluation prompt sentence from Step 18.

Output: a natural language feedback text describing strengths, weaknesses, and recommended actions.

The server may segment this text into fields such as “summary”, “weak points”, and “next actions” using delimiters or markers in the model output.

### Step 20:

The server generates a prompt sentence for learning plan creation.

The server composes a planning prompt that includes the understanding profile, user attribute information (for example, education level), progress indices, and optionally emotional state information.

Input: the updated understanding profile, progress indices, and optional emotional state information.

Output: a planning prompt sentence that asks for a multi-day or multi-session learning plan.

For example, the server may generate:

“Generate a 7-day learning plan for a learner who is weak in definite integrals (scores: easy 40%, medium 20%) and strong in limits (scores: easy 90%, medium 85%). Include daily objectives, recommended difficulty levels, and number of practice problems per day.”

### Step 21:

The server invokes the generative AI model to generate a learning plan candidate.

The server processes the planning prompt with the generative AI model and receives a plan description, typically including daily steps, topics, and task types.

Input: the planning prompt sentence from Step 20.

Output: a raw plan text that includes a proposed sequence of topics, target difficulties, and counts of tasks per day or session.

The server enforces maximum length and structure by using decoding constraints and by expecting specific labeled sections in the output.

### Step 22:

The server parses and validates the learning plan candidate, and enriches it with concrete resources.

The server parses the plan text into structured entries (for example, day number, subtopic, difficulty, number of tasks). The server checks each entry against allowed topics and difficulty ranges, and then queries the resource table to attach matching learning materials (such as videos, documents, and exercise sets).

Input: the raw plan text from Step 21 and the resource metadata stored in the resource table.

Output: structured learning plan information that lists concrete tasks and resources per step.

The server discards or modifies plan steps that violate constraints (for example, unavailable topic, unsupported difficulty) and rebalances the plan if necessary.

### Step 23:

The server generates notification information and dashboard update data.

The server compares current progress indices with thresholds (for example, minimal weekly activity or sustained low performance in a topic) to determine whether to generate support requests or instructor intervention requests. The server also creates visual representation data (charts, timelines, summary cards) reflecting the new understanding profile and plan.

Input: the updated understanding profile, progress indices, and learning plan information from Step 22.

Output: notification objects for the user and/or instructor, and visual representation data structures for the dashboard.

The server records notifications in the notification table and packages visualization data into a compact format for transmission to terminals.

### Step 24:

The server sends evaluation results, learning plan information, and visualization data to the terminal.

The server constructs a response payload that includes numeric scores, explanatory text, plan entries, and dashboard configuration.

Input: the feedback text, structured learning plan, notification information, and visualization data from Step 23.

Output: an HTTP response containing JSON structures that the terminal can render as result screens, dashboards, and alerts.

The server also updates status fields to indicate that the plan has been delivered.

The terminal presents feedback, the learning plan, and dashboard views to the user.

The terminal interprets the received JSON, renders the scores and evaluation text, and displays the learning plan as a list or calendar. The terminal also initializes interactive dashboard elements (graphs, filters, detail views) based on the visual representation data.

Input: the HTTP response payload received in Step 24.

Output: visual displays on the terminal's screen and any local state needed for user interaction.

The terminal may highlight recommended next actions and present notification messages such as support suggestions or instructor contact prompts.

### Step 26:

The user reviews the feedback and initiates subsequent learning actions.

The user inspects scores, explanations, and the learning plan, and chooses to start the next recommended session, review weak topics, or request additional support.

Input: the on-screen feedback, plan, and dashboard rendered by the terminal.

Output: new user interactions (for example, “start session”, “review topic”) that the terminal logs as events and sends back to the server as part of ongoing learning activity logs.

These interactions trigger another cycle of task selection, evaluation, and plan adaptation according to the preceding steps.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

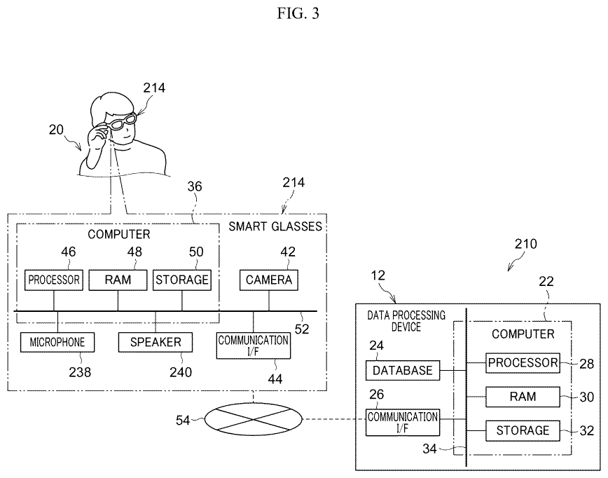

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

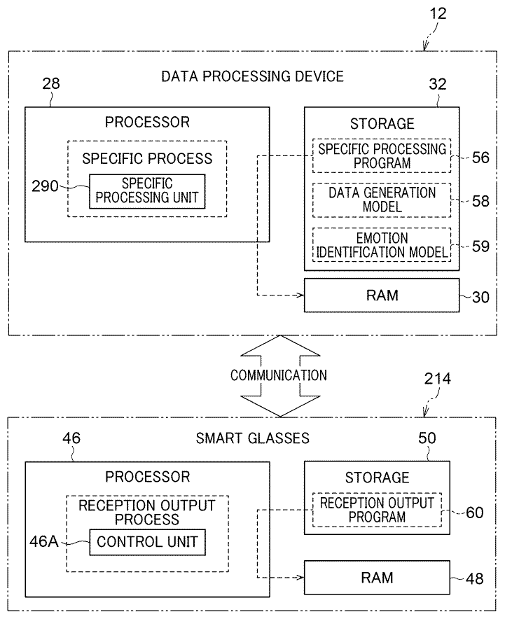

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

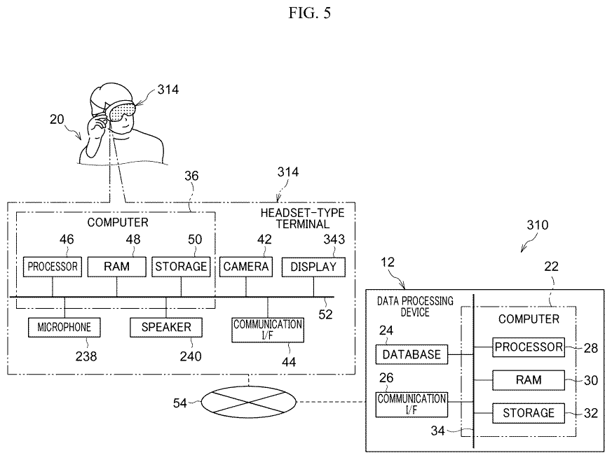

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

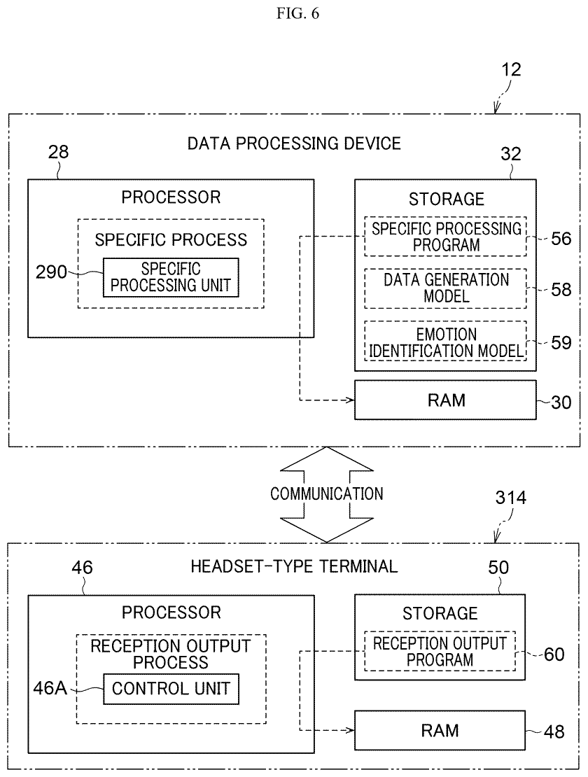

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

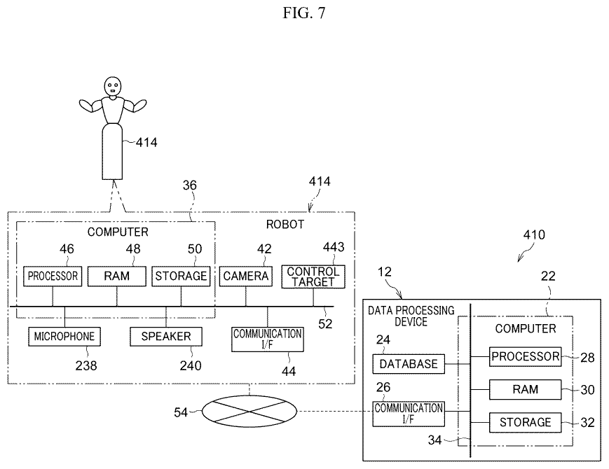

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

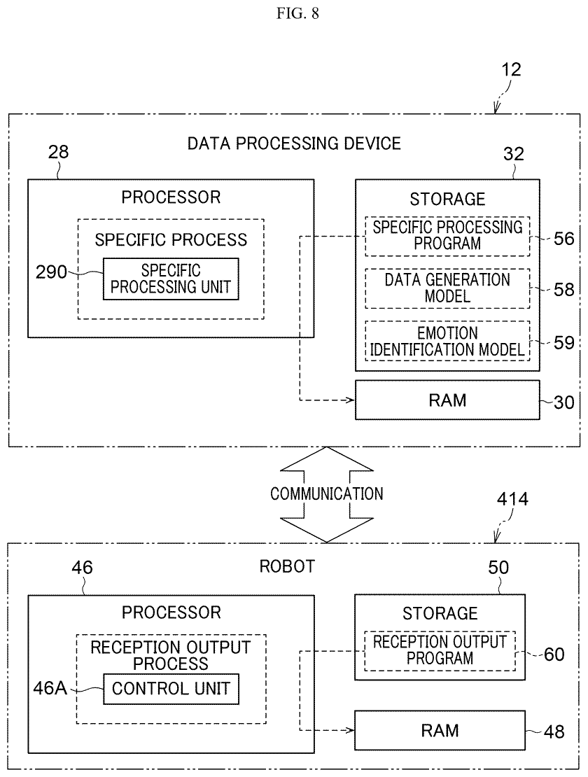

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

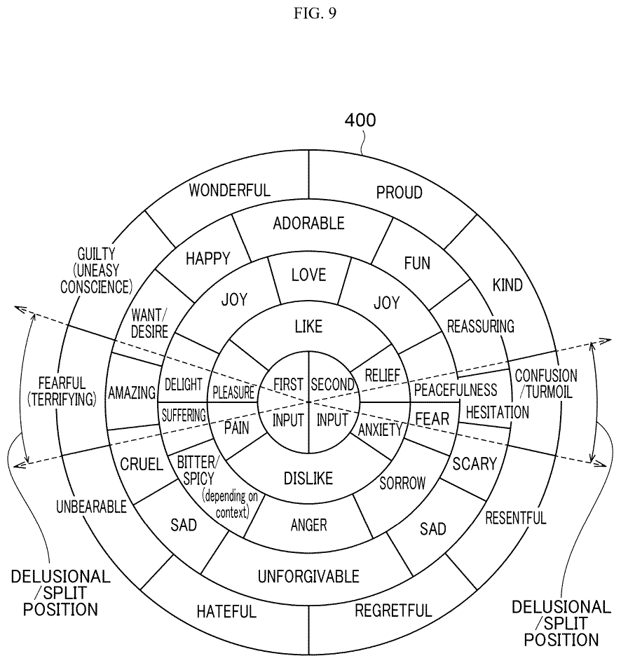

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

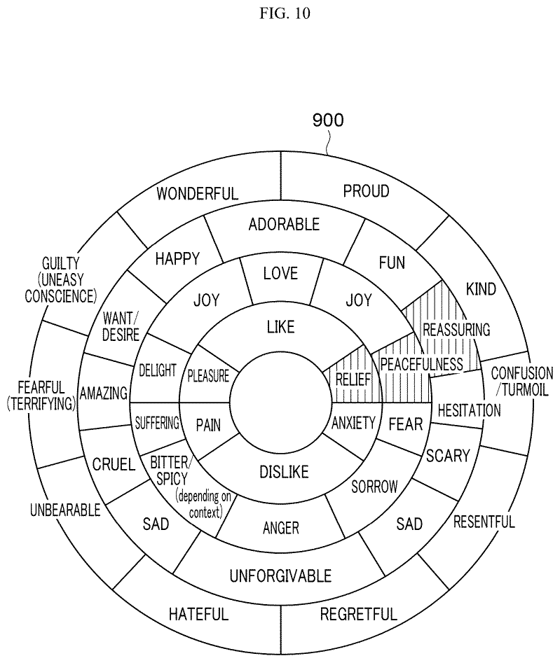

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a memory storing instructions,
wherein the processor is configured to
receive, from a user terminal, learning target information selected by a user via a user interface of the user terminal, and generate learning request information including identification information associated with the learning target information; and
perform a search process on a set of problem information stored in a storage device, based on the learning request information, to extract problem information related to the learning target information, and select problem information having a plurality of difficulty levels in accordance with a learner level estimated from past usage history information and evaluation result information; and
transmit the selected problem information to the user terminal, receive answer information from the user terminal, perform correctness determination and partial-match determination of the answer information in accordance with predefined evaluation criterion information, and calculate a numerical comprehension index of a learner based on a result of the determinations; and
input the comprehension index and the usage history information as feature data into a machine learning algorithm, and calculate learner state information indicating at least a learning level of the learner and topic-wise proficiency of the learner; and
generate, based on the learner state information and the learning target information, a prompt sentence in a natural language that specifies at least one of learning plan information, learning material information, and learning method information as learning proposal content, and transmit the prompt sentence as input data to a generative AI model; and
receive response information from the generative AI model, structure the learning proposal content of the response information into structured data, store the structured data in the storage device in association with the comprehension index and the learner state information, and transmit the structured data as output data to the user terminal; and
calculate a learning progress degree based on at least the learner state information, the usage history information, and the answer information, and, when the learning progress degree satisfies a predetermined condition, generate notification information including support request information or instructor intervention request information, and transmit the notification information to at least one of the user terminal and an instructor terminal; and
execute a filtering algorithm that performs a re-search process and a filtering process on the set of problem information based on at least the learner state information and the learning progress degree, and select problem information suitable for a current learning level of the learner and a weak area of the learner; and
generate, based on at least the learner state information, the learning target information, and condition information including a desired problem format, a prompt sentence that explicitly specifies an output format and a difficulty condition, input the prompt sentence to the generative AI model to cause the generative AI model to generate new problem information, and integrate the new problem information with the problem information selected by the re-search process and the filtering process; and
generate visualization data indicating a learning situation on a time axis and on a topic basis, based on at least the comprehension index, the learner state information, and the learning progress degree, and transmit the visualization data to the user terminal so that an interactive display screen on which a user and an instructor can confirm the learning situation is provided.

### (Supplementary 2)

The system according to supplementary 1,
wherein the processor is configured to
dynamically update the prompt sentence according to learner profile information including at least the learner state information, the learning progress degree, topic-wise proficiency, and previously presented learning plan information, and, based on response information received from the generative AI model, sequentially change contents and presentation order of the learning plan information, the learning material information, and the learning method information.

### (Supplementary 3)

The system according to supplementary 1,
wherein the processor is configured to
recalculate, at a predetermined update cycle or upon occurrence of a predetermined event, at least the learner state information, the comprehension index, and the answer information,
generate the visualization data based on a result of the recalculation, and provide, to the user terminal, an interactive display screen having a data update function that allows the user and the instructor to confirm a learning level and learning progress of the learner in substantially real time.

### Application Example 1

### (Supplementary 1)

A system comprising a processor and a storage apparatus,
wherein the processor is configured to
receive learning information and learner attribute information from a learner terminal, perform a search process on a problem data set stored in the storage apparatus based on the learning information and the learner attribute information, extract problems associated with a plurality of difficulty levels, and select a problem group adapted to a learning level of a learner from the extracted problems,
receive answer information transmitted from the learner terminal, evaluate the answer information based on the problem data set or evaluation criterion data stored in the storage apparatus, calculate a comprehension index for each learner based on an evaluation result, and store the comprehension index as learning history information in the storage apparatus, generate a prompt sentence that instructs generation of learning support content including at least a learning plan, learning materials, and learning methods based on the comprehension index and the learning history information, input the prompt sentence into a generative AI model, and acquire the learning support content output from the generative AI model,
analyze a progress state of learning activities in a time series based on the learning history information and the comprehension index, detect learning stagnation or performance degradation according to a predetermined condition, and generate notification information including an intervention request or support guidance to be transmitted to at least one of the learner and a supporter in accordance with a detection result,
perform a search process again on the problem data set based on at least one of the learning information, the comprehension index, and the learning history information, narrow down problem candidates by applying a filtering algorithm according to at least one of problem presentation history, correct answer rate, answer time, and difficulty level, and reselect an optimized problem group for each learner,
generate a prompt sentence representing problem generation conditions based on at least one of the learning information, the comprehension index, and a shortage state of the problem data set, input the prompt sentence into the generative AI model, cause the generative AI model to generate new problem data corresponding to a specified difficulty level, question format, and content domain, and integrate the new problem data into the problem data set and the problem group, and
generate server response data including at least the learning support content and the new problem data, transmit the server response data to the learner terminal, and cause display control of the learner terminal to dynamically update at least a problem presentation screen and a feedback screen.

### (Supplementary 2)

The system according to supplementary 1,
wherein the processor is configured to
generate the prompt sentence by using, as input, at least the comprehension index, the learning history information, a correctness tendency of already presented problems, and residence time information, extract feature information indicating a weak field and a strong field for each learner, and dynamically generate, based on the feature information, a prompt sentence including contents of the learning plan, the learning materials, and the learning methods and conditions for stepwise changing at least a difficulty transition and a learning schedule, and input the prompt sentence into the generative AI model.

### (Supplementary 3)

The system according to supplementary 1,
wherein the processor is configured to
generate visualization data by aggregating, based on the notification information and the comprehension index, at least a progress degree, an achievement degree, a weak field, and
learning time for each learner, and provide the visualization data, as configuration information of an interactive display screen whose display contents are automatically updated in response to a display update request, to at least the learner terminal and a supporter terminal so as to visualize a learning level and a learning progress in real time.

### Example 2

### (Supplementary 1)

A system comprising a processor,
wherein the processor is configured to
accept, via a terminal, an operation in which a user selects learning target information and problem conditions,
generate, based on the learning target information and the problem conditions, a prompt sentence for input to a generative AI model by performing character string processing, and transmit request data including the prompt sentence to the generative AI model via a communication path,
acquire problem information generated by the generative AI model on the basis of the prompt sentence, and analyze the problem information into a predetermined data structure to extract each question, each choice, and correct answer information,
generate, based on the extracted problem information, screen data for an online test by using a markup language and a scripting language, and distribute the screen data to the terminal,
acquire answer data of the user transmitted from the terminal, compare the answer data with the correct answer information to determine correctness or incorrectness for each question, and calculate a number of correct answers and a correct answer rate by performing arithmetic operations,
classify a level of understanding into a plurality of stages on the basis of the calculated correct answer rate, and generate feedback information according to a result of the classification,
dynamically generate, on the basis of the level of understanding and learning history information, a prompt sentence for additional learning problem generation or learning plan proposal, and input the prompt sentence to the generative AI model to acquire supplementary problems or a learning plan proposal, and
transmit the level of understanding, the feedback information, and the supplementary problems or the learning plan proposal to the terminal, and generate display control information for visually displaying a learning level by storing learning progress in a time-series manner.

### (Supplementary 2)

The system according to supplementary 1,
wherein the processor is configured to
generate, in generating the prompt sentence, condition information to dynamically change contents of proposals regarding a learning plan, learning material, and learning method in accordance with the level of understanding, the correct answer rate, and the learning history information, and update learning proposal information on the basis of an output result acquired from the generative AI model.

### (Supplementary 3)

The system according to supplementary 1,
wherein the processor is configured to
generate, in generating the display control information, structured data and drawing control data for visualizing the learning level, the correct answer rate, and chronological test results as an interactive dashboard having a data update function, and enable a learner and an instructor to confirm learning progress in real time by display processing on the terminal.

### Application Example 2

### (Supplementary 1)

A system comprising a processor,
wherein the processor is configured to
acquire learning target information selected by a user through an information processing apparatus, search task information stored in a storage apparatus based on the learning target information, and select task information having a plurality of difficulty levels according to a difficulty attribute, and
receive answer information acquired from a user terminal, determine correctness of each task according to an evaluation criterion based on the answer information, calculate understanding degree indices by field and by difficulty through statistical processing to numericalize an understanding degree, and record the numericalized understanding degree as an understanding profile, and
generate, based on the understanding profile and evaluation results including user attribute information, a prompt sentence for instructing a generative information processing model to generate a learning plan candidate and to interpret the understanding degree, input the prompt sentence to the generative information processing model, and generate learning plan information by integrating the learning plan candidate and explanation information relating to the understanding degree, which are acquired from the generative information processing model, with the understanding profile, and
search teaching resource information and training resource information from an educational resource storage apparatus based on learning contents and difficulty information included in the learning plan information, and select learning material information and learning method information in association with the learning plan information, and
aggregate learning progress in a time series based on learning activity log information acquired from a learning terminal, calculate progress indices to monitor a progress state, and generate notification information including a support request or an instructor intervention request based on the progress indices and the understanding profile, and
search related task information again from the storage apparatus based on the learning target information and the understanding profile, select task information adapted to a learning level of the user by applying a filtering algorithm, and configure a task set, and
when a predetermined number or a predetermined distribution of tasks is insufficient in the task set, generate a prompt sentence including topic information, target difficulty information, educational purpose information, and the understanding profile, input the prompt sentence to the generative information processing model to cause the generative information processing model to generate new task candidates, convert the generated task candidates into structured data, perform verification and formatting processing, and additionally register the generated task candidates into the task set, and
generate visual representation data based on the understanding profile, the learning progress, and the explanation information acquired from the generative information processing model, and provide the visual representation data as updatable display information for presentation to a learner and an instructor.

### (Supplementary 2)

The system according to supplementary 1,
wherein the processor is configured to
update the prompt sentence in accordance with context information including the understanding degree indices, progress indices, user attribute information, and emotional state information, and to generate the prompt sentence so as to include a description that instructs the generative information processing model to generate a dynamic learning plan candidate in which contents of a learning plan, learning materials, and learning methods change over time, and to sequentially change proposal contents of the learning plan, the learning materials, and the learning methods according to the understanding degree and the learning progress of the user.

### (Supplementary 3)

The system according to supplementary 1,
wherein the processor is configured to
in generating the visual representation data, configure learning state information including the understanding degree indices, the progress indices, a task execution history, and a notification history as interactive display elements in an updatable display region, and automatically redraw the display elements whenever the learning state information is updated, thereby providing an interactive dashboard that allows the learner and the instructor to substantially confirm the learning progress in real time.

What is claimed is:

1. A system comprising:
circuitry configured to:
receive, via a packet-switched network from a terminal, selection data indicating a target information domain, and execute a search process on a set of task records stored in a storage to retrieve task records associated with the target information domain and select task records having a plurality of difficulty attribute values;
transmit the selected task records as data packets via the packet-switched network to the terminal, receive answer data from the terminal, evaluate the answer data against evaluation criterion data associated with each task record, and compute a comprehension index representing a quantified assessment result for a user;
generate, based on the comprehension index and usage history data, a prompt sequence expressed as a natural-language instruction specifying content parameters for a generative model, and transmit the prompt sequence as data packets via the packet-switched network to a generative model node;
receive response data from the generative model node, structure the response data into a predetermined data format, and store the structured response data in association with the comprehension index in the storage;
compute a progress metric based on the comprehension index, the usage history data, and the answer data, and, when the progress metric satisfies a predetermined condition, generate notification data and transmit the notification data as data packets via the packet-switched network to at least one destination terminal; and
execute a filtering algorithm on the set of task records based on the comprehension index and the progress metric to select task records adapted to a current assessment level, generate a further prompt sequence specifying output format constraints and difficulty conditions, and transmit the further prompt sequence to the generative model node to cause generation of new task record data.

2. The system according to claim 1, wherein the circuitry is configured to normalize the selection data into a structured request record including identification information mapped to the target information domain, and perform the search process by querying the storage using the identification information and a learner level estimated from the usage history data.

3. The system according to claim 2, wherein the circuitry is configured to evaluate the answer data by performing correctness determination and partial-match determination against the evaluation criterion data, and compute the comprehension index as a numerical value derived from a ratio of correct evaluations to total evaluations.

4. The system according to claim 3, wherein the circuitry is configured to input the comprehension index and the usage history data as feature data into a classification algorithm and compute learner state data indicating a learning level and topic-specific proficiency values for the user.

5. The system according to claim 1, wherein the prompt sequence includes instruction items specifying at least one of plan content parameters, material content parameters, and method content parameters derived from the comprehension index, and wherein the circuitry is configured to structure the response data by extracting plan elements, material elements, and method elements into respective fields of the predetermined data format.

6. The system according to claim 5, wherein the circuitry is configured to generate a dynamic prompt sequence that instructs the generative model node to produce content in which plan content, material content, and method content vary in accordance with changes in the comprehension index and the progress metric over successive interactions.

7. The system according to claim 6, wherein the circuitry is configured to update the prompt sequence in accordance with context data including the comprehension index, the progress metric, user attribute data, and emotional state data estimated from sensor data received from the terminal.

8. The system according to claim 1, wherein the filtering algorithm applies filtering conditions based on at least one of task presentation history data, correct answer rate data, answer time data, and difficulty attribute values to narrow candidate task records from the set of task records.

9. The system according to claim 8, wherein the circuitry is configured to determine whether a number of task records in a filtered task set satisfies a predetermined threshold, and, when the number is insufficient, generate the further prompt sequence including topic information, target difficulty information, and format specification information, and transmit the further prompt sequence to the generative model node to cause generation of supplementary task records.

10. The system according to claim 9, wherein the circuitry is configured to receive the supplementary task records from the generative model node, parse the supplementary task records into the predetermined data format by extracting question data, option data, and correct answer data, perform verification processing on the parsed data, and integrate verified supplementary task records into the set of task records in the storage.

11. The system according to claim 10, wherein the circuitry is configured to generate screen rendering data for the terminal by encoding the integrated task records using a markup language and a scripting language, and transmit the screen rendering data as data packets via the packet-switched network to the terminal for display.

12. The system according to claim 1, wherein the notification data includes at least one of support request data and intervention request data, and wherein the circuitry is configured to generate the notification data when the progress metric indicates at least one of learning stagnation and performance degradation relative to a baseline value computed from the usage history data.

13. The system according to claim 12, wherein the circuitry is configured to transmit the notification data to both the terminal associated with the user and a separate instructor terminal via the packet-switched network.

14. The system according to claim 1, wherein the circuitry is configured to generate visualization data representing the comprehension index and the progress metric on a time axis and on a topic basis, and transmit the visualization data as data packets via the packet-switched network to the terminal for rendering as an interactive display region having a data update function.

15. The system according to claim 14, wherein the visualization data includes display elements representing the comprehension index, the progress metric, task execution history data, and notification history data, and wherein the circuitry is configured to automatically regenerate the display elements when underlying data is updated.

16. The system according to claim 1, wherein the circuitry is configured to acquire image data and audio data from sensors at the terminal, transmit the image data and the audio data to an emotion analysis model, receive emotional state data from the emotion analysis model, and use the emotional state data as context data for modifying the prompt sequence.

17. The system according to claim 16, wherein the circuitry is configured to store the emotional state data in association with the comprehension index and the progress metric as time-series records in the storage, and use the time-series records as input features for computing updated learner state data.

18. A system comprising:
circuitry configured to:
receive selection data indicating a target information domain from a terminal via a packet-switched network;
execute a search process on task records in a storage based on the selection data and select task records having a plurality of difficulty attribute values;
receive answer data from the terminal, evaluate the answer data, and compute a comprehension index;
generate a prompt sequence based on the comprehension index and transmit the prompt sequence to a generative model node via the packet-switched network;
receive response data from the generative model node and store structured response data in the storage;
compute a progress metric and generate notification data when the progress metric satisfies a predetermined condition; and
execute a filtering algorithm to select task records adapted to a current assessment level and generate a further prompt sequence to cause the generative model node to generate new task record data.

19. The system according to claim 18, wherein the circuitry is configured to determine whether a number of task records selected by the filtering algorithm is insufficient, and, when insufficient, transmit the further prompt sequence including difficulty conditions and format specifications to cause the generative model node to generate supplementary task records for integration into the storage.

20. A method performed by circuitry, the method comprising:
receiving, via a packet-switched network from a terminal, selection data indicating a target information domain, and executing a search process on a set of task records stored in a storage to retrieve task records associated with the target information domain and select task records having a plurality of difficulty attribute values;
transmitting the selected task records as data packets via the packet-switched network to the terminal, receiving answer data from the terminal, evaluating the answer data against evaluation criterion data associated with each task record, and computing a comprehension index representing a quantified assessment result for a user;
generating, based on the comprehension index and usage history data, a prompt sequence expressed as a natural-language instruction specifying content parameters for a generative model, and transmitting the prompt sequence as data packets via the packet-switched network to a generative model node;
receiving response data from the generative model node, structuring the response data into a predetermined data format, and storing the structured response data in association with the comprehension index in the storage;
computing a progress metric based on the comprehension index, the usage history data, and the answer data, and, when the progress metric satisfies a predetermined condition, generating notification data and transmitting the notification data as data packets via the packet-switched network to at least one destination terminal; and
executing a filtering algorithm on the set of task records based on the comprehension index and the progress metric to select task records adapted to a current assessment level, generating a further prompt sequence specifying output format constraints and difficulty conditions, and transmitting the further prompt sequence to the generative model node to cause generation of new task record data.
